(19) United States
(12) Patent Application Publication
(10) Pub. No.: US 2016/0045063 A1
(43) Pub. Date: Feb. 18, 2016

(54) BLENDER RINSE ASSEMBLY

(71) Applicant: Manitowoc Foodservice Companies, LLC, Manitowoc, WI (US)

(72) Inventors: Paul Douglas Mantle, Crestwood, KY (US); Michael Merritt, Louisville, KY (US); Paul Hanniffy, Louisville, KY (US); Gorm Bressner, Providence, RI (US); Janice M.K. Jaferian, Palm Harbor, FL (US); Jan Claesson, Land O' Lakes, FL (US)

(21) Appl. No.: 14/826,706

(22) Filed: Aug. 14, 2015

Related U.S. Application Data
(60) Provisional application No. 62/037,393, filed on Aug. 14, 2014.

(51) Int. Cl. A47J 31/60

(52) U.S. Cl. CPC A47J 31/60

(57) ABSTRACT

To clean the interior of a blend chamber, alternative rinse assembly structures and methods are described that use various shapes of holes or orifices through which water, which may contain cleaning or sanitizing fluid, can be dispersed as either continuous or pulsated streams directed at various portions of the blend chamber interior. A rinse assembly may include a grate having a frame forming a plurality of apertures, and a conduit having a wall surrounding an interior cavity. The conduit has a curved shaping with a plurality of holes through the wall.

This application claims the benefit of U.S. Provisional Application No. 62/037,393, filed Aug. 14, 2014. The contents of U.S. Provisional Application No. 62/037,393, filed Aug. 14, 2014, are hereby incorporated by reference herein in their entirety.

### BACKGROUND OF THE DISCLOSURE

1. Field of the Disclosure

The present disclosure relates generally to a blender assembly. More particularly, the present disclosure relates to a blender assembly that has a rinse function.

2. Description of Related Art

Beverages, for example, a smoothie drink, can require blending of beverage ingredients including ice, flavor ingredients, and other solid or liquid ingredients during a blending cycle. Flavor ingredients include liquid flavor ingredients, for example, fruit juice and chocolate syrup, and solid ingredients, for example, nutraceuticals, vitamins, herbs, spices, berries and other fruits, vegetables, such as spinach, celery, beets, tomatoes, cucumbers, or carrots, or pieces of fruit, vegetables or candies, such as solid chocolate pieces, apple or orange segments, or cut up vegetables. Herbs such as mint, parsley, sage, rosemary, thyme, and any other herbs. Spices such as cayenne, cinnamon, curry, nutmeg and any other spices.

Many challenges are encountered during a blending cycle. For blenders, for example, automatic Blend-in-cup machines, there is a need to perform many functions. One function that exists is to rinse the blend chamber, blades, cup cover, etc. after completion of a blending cycle and before the next blending cycle occurs. This rinse is vital to ensure a previous product of a beverage is not mixed into the next consumer's cup to ensure consumer gets their requested drink without cross product contamination. It is desirable that such a rinse assembly minimizes the number of parts that themselves also need periodic sanitizing.

Accordingly, it has been determined by the present disclosure, there is a need for integration of the rinsing feature and a cup structural placement feature. It has been further determined by the present disclosure that there is a need for a rinse assembly that minimizes the number of parts and that can be easily maintained.

### SUMMARY

A rinse assembly includes a grate having a frame forming a plurality of apertures, and a conduit having a wall surrounding an interior cavity. The conduit has a curved shaping with a plurality of holes through the wall. The conduit and grate form a one-piece structure.

A rinse assembly is also provided that includes a conduit having a wall surrounding an interior cavity. The conduit has a curved shaping with a plurality of holes through the wall. The conduit has a first end having a first opening and a second end having a second opening. A first end cap is connectable to the conduit. The first end cap has a first unlocked position in which the first end cap is removable from the conduit and a first locked position in which the first end cap is fixed to the conduit. A second end cap is connectable to the conduit. The second end cap has a second unlocked position in which the second end cap is removable from the conduit and a second locked position in which the second end cap is fixed to the conduit.

A rinse assembly is further provided that includes a conduit having a wall surrounding an interior cavity. The conduit has a curved shape with a plurality of holes through the wall. The wall of the conduit directly contacts a surface of a blend chamber in a blender.

The above-described and other advantages and features of the present disclosure will be appreciated and understood by those skilled in the art from the following detailed description, drawings, and appended claims.

### BRIEF DESCRIPTION OF THE DRAWINGS

FIG. 1 is a top side perspective view of a first embodiment of a rinse assembly according to the present disclosure.

FIG. 1A is a top side perspective view of an alternative shape of the first embodiment of the rinse assembly.

FIG. 1B is a top front perspective view of the alternative shape of the rinse assembly of FIG. 1A in a blender assembly.

FIG. 1C is a top front perspective view of the rinse assembly of FIG. 1B having holes with a star shape in the blender assembly.

FIG. 2 is a top side perspective view of a blender assembly having the rinse assembly of FIG. 1.

FIG. 3 is a front cross-sectional view of the blender assembly having the rinse assembly of FIG. 1 showing a direction of water flow through holes in the rinse assembly.

FIG. 4 is a side cross-sectional view of the blender assembly having the rinse assembly of FIG. 1 showing the direction of water flow through the holes in the rinse assembly.

FIG. 5 is an enlarged side cross-sectional view of a portion of the blender assembly having the rinse assembly of FIG. 1.

FIG. 6 is an enlarged side cross-sectional view of a portion of the blender assembly having the rinse assembly of FIG. 1 showing an open end seal.

FIG. 7 is an enlarged side cross-sectional view of a portion of the blender assembly having the rinse assembly of FIG. 1 showing an inlet end seal.

FIG. 8 is a top cross-sectional view of the blender assembly having the rinse assembly of FIG. 1.

FIG. 9 is an enlarged top cross-sectional view of a portion of the blender assembly having the rinse assembly of FIG. 1 showing the inlet end seal.

FIG. 10 is an enlarged top cross-sectional view of a portion of the blender assembly having the rinse assembly of FIG. 1 showing the open end seal.

FIG. 11 is a top side perspective view of the rinse assembly of FIG. 1 having an upper portion removed.

FIG. 12 is a bottom side perspective view of the rinse assembly of FIG. 1 having a lower portion removed.

FIG. 13 is a top side perspective view of the inlet end seal.

FIG. 14 is an enlarged partial top side perspective view of the rinse assembly of FIG. 1 showing the inlet end seal.

FIG. 15 is a top side perspective view of the open end seal.

FIG. 16 is an enlarged partial top side perspective view of the rinse assembly of FIG. 1 showing the open end seal.

FIG. 17A is an enlarged partial side cross-sectional view of the rinse assembly of FIG. 1 showing one of the holes.

FIG. 17AA is an enlarged partial side cross-sectional view of the rinse assembly of FIG. 1 showing one of the holes having an adjustable jet.

FIG. 17A′ is a top front perspective view of the rinse assembly of FIG. 1 showing the holes having adjustable jets in the blender assembly.

FIG. 17A″ is an enlarged partial side cross-sectional view of the rinse assembly of FIG. 1 showing one of the holes having the adjustable jet.

FIG. 17B is top side perspective view of an alternative rinse assembly of the present disclosure having an insert.

FIG. 17C is top side perspective view of the alternative rinse assembly of FIG. 17B having the insert removed.

FIG. 17D is top side perspective view of the insert of FIG. 17B.

FIG. 17E is a bottom side perspective view of an upper portion of the alternative rinse assembly of FIG. 17B.

FIG. 17EE is a top side perspective view of the upper portion of the alternative rinse assembly of FIG. 17B.

FIG. 17E′ is a top side perspective view of a lower portion of the alternative rinse assembly of FIG. 17B.

FIG. 17F is an enlarged side cross-sectional view of a portion of a blender assembly having the alternative rinse assembly of FIG. 17B.

FIG. 17G is an enlarged side cross-sectional view of a portion of a blender assembly having the alternative rinse assembly of FIG. 17B.

FIG. 17H is an enlarged front top side perspective view of a spring keeper assembly of the alternative rinse assembly of FIG. 17B.

FIG. 17I is an enlarged rear top side perspective view of the spring keeper assembly of the alternative rinse assembly of FIG. 17B.

FIG. 17J is an enlarged front top side perspective view of a spring of the alternative rinse assembly of FIG. 17B.

FIG. 18 is a top side perspective view of a second embodiment of a rinse assembly according to the present disclosure.

FIG. 18A is a top side perspective view of an alternative shape of the second embodiment of the rinse assembly.

FIG. 19 is a top side perspective view of a blender assembly having the rinse assembly of FIG. 18.

FIG. 20 is a front cross-sectional view of the blender assembly having the rinse assembly of FIG. 18 showing a direction of water flow through holes in the rinse assembly.

FIG. 21 is an enlarged side cross-sectional view of a portion of the blender assembly having the rinse assembly of FIG. 18.

FIG. 22 is an enlarged side cross-sectional view of a portion of the blender assembly having the rinse assembly of FIG. 18 showing an open end seal with a cap.

FIG. 23 is an enlarged side partial cross-sectional view of the rinse assembly of FIG. 18 showing the open end seal with the cap.

FIG. 24 is an enlarged side cross-sectional view of a portion of the blender assembly having the rinse assembly of FIG. 18 showing an inlet end seal.

FIG. 25 is an enlarged top cross-sectional view of a portion of the blender assembly having the rinse assembly of FIG. 18.

FIG. 26 is an enlarged top cross-sectional view of a portion of the blender assembly having the rinse assembly of FIG. 18 showing the inlet end seal.

FIG. 27 is an enlarged top cross-sectional view of a portion of the blender assembly having the rinse assembly of FIG. 18 showing the open end seal with the cap.

FIG. 28 is a bottom side perspective view of the rinse assembly of FIG. 18 having an upper portion removed.

FIG. 29 is a bottom side perspective view of the rinse assembly of FIG. 18 having a lower portion removed.

FIG. 30A is an enlarged side cross-sectional view of the cap.

FIG. 30B is an enlarged bottom side perspective view of the cap.

FIG. 31A is an enlarged partial side cross-sectional view of the rinse assembly of FIG. 18 showing the open end seal with the cap.

FIG. 31B is an enlarged partial rear cross-sectional view of the rinse assembly of FIG. 18 showing the open end seal with the cap.

FIG. 32 is an enlarged partial side cross-sectional view of the rinse assembly of FIG. 18 showing one of the holes.

FIG. 32A is an enlarged partial side cross-sectional view of the rinse assembly of FIG. 18 showing one of the holes having an adjustable jet.

FIG. 33 are top side perspective views of another rinse assembly, the rinse assembly of FIG. 18 and the rinse assembly of FIG. 17B.

FIG. 34 is a top side perspective view of a third embodiment of a rinse assembly according to the present disclosure.

FIG. 34A is a top side perspective view of a blender assembly having rinse assembly of FIG. 34 having an alternative shape.

FIG. 35 is a top side perspective view of a blender assembly having a fourth embodiment of a rinse assembly according to the present disclosure.

FIG. 35A is a top side perspective view of a blender assembly having rinse assembly of FIG. 35.

FIG. 35A′ is a top side cross-sectional view of the rinse assembly of FIG. 35A.

FIG. 36 is an enlarged side cross-sectional view of a portion of a blender assembly having a fifth embodiment of a rinse assembly according to the present disclosure.

FIG. 36A is a side front view of a portion of the blender assembly having the rinse assembly of FIG. 36.

FIG. 37 is a top side perspective view of a portion of a blender assembly having a sixth embodiment of a rinse assembly according to the present disclosure.

FIG. 37A is a top front perspective view of a portion of a blender assembly with a portion of the side wall removed having the rinse assembly of FIG. 37.

FIG. 38 is a top side perspective view of a portion of a blender assembly having a seventh embodiment of a rinse assembly according to the present disclosure.

FIG. 38A is a top front perspective view of a portion of a blender assembly having the rinse assembly of FIG. 38 having a conduit with an alternative shape.

FIG. 39 is a front cross-sectional view of a portion of a blender assembly having an eighth embodiment of a rinse assembly according to the present disclosure.

### DETAILED DESCRIPTION OF THE DISCLOSURE

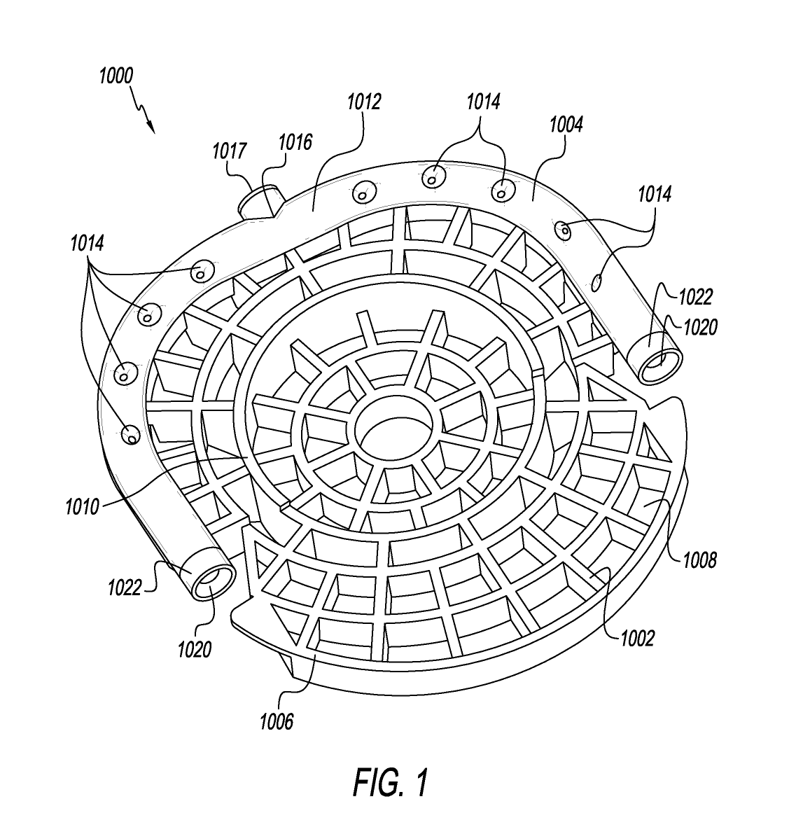

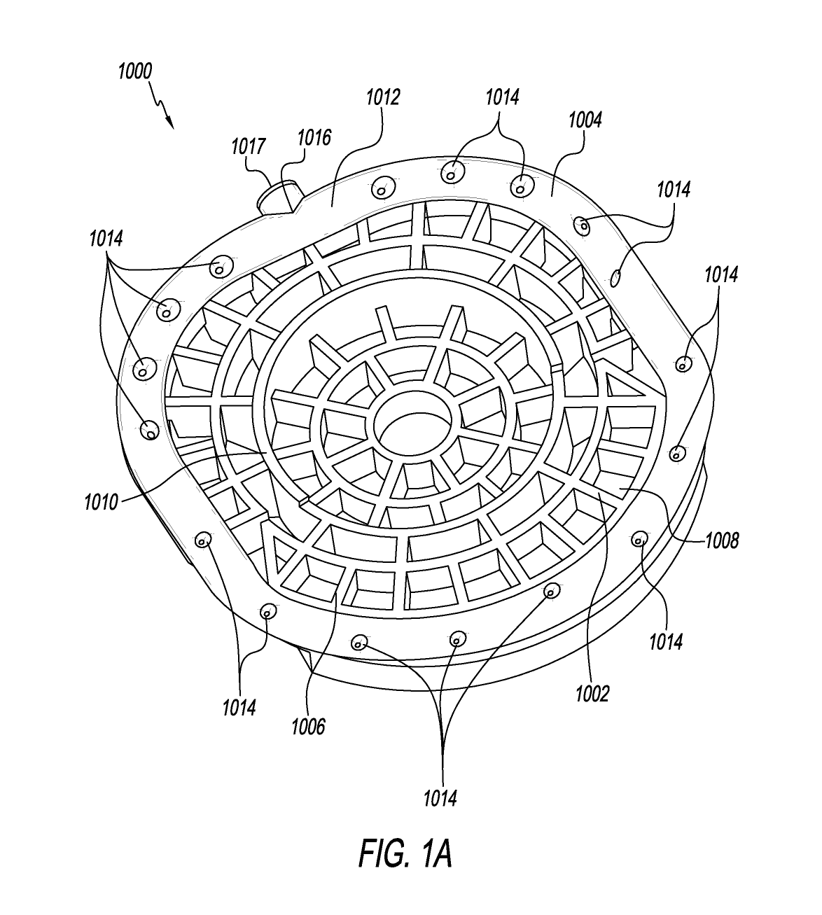

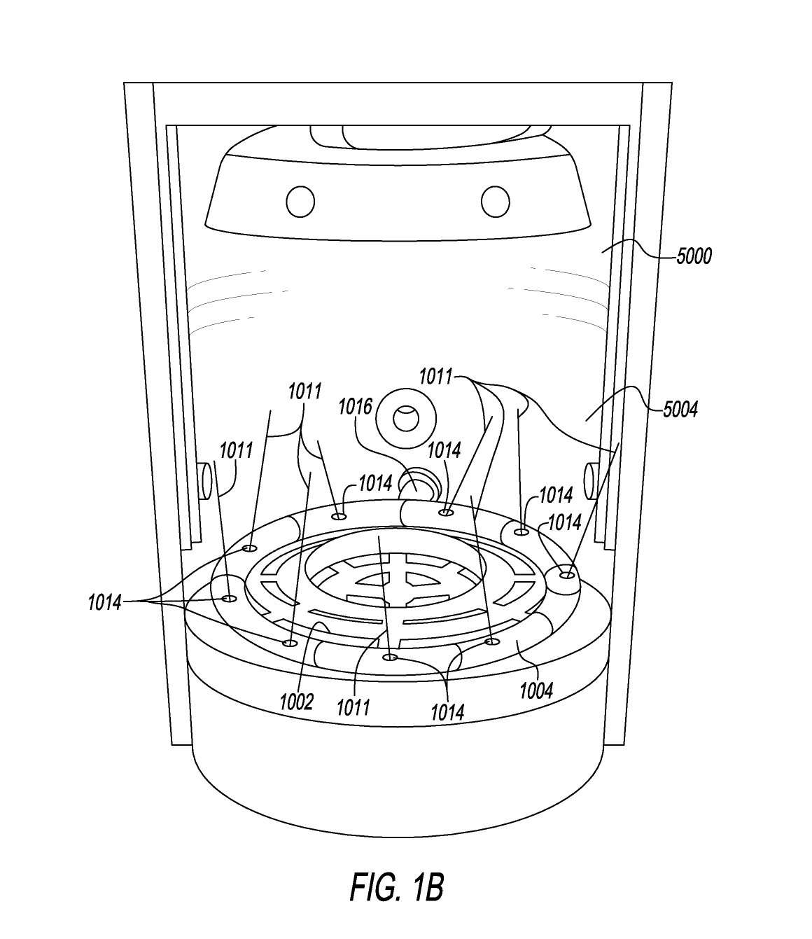

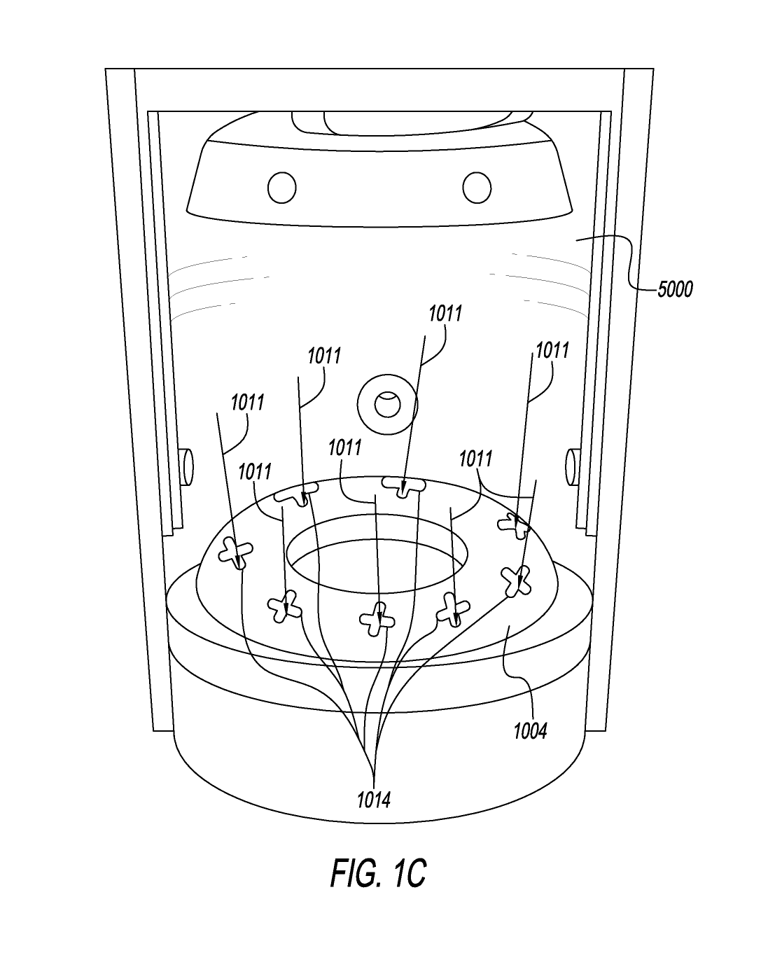

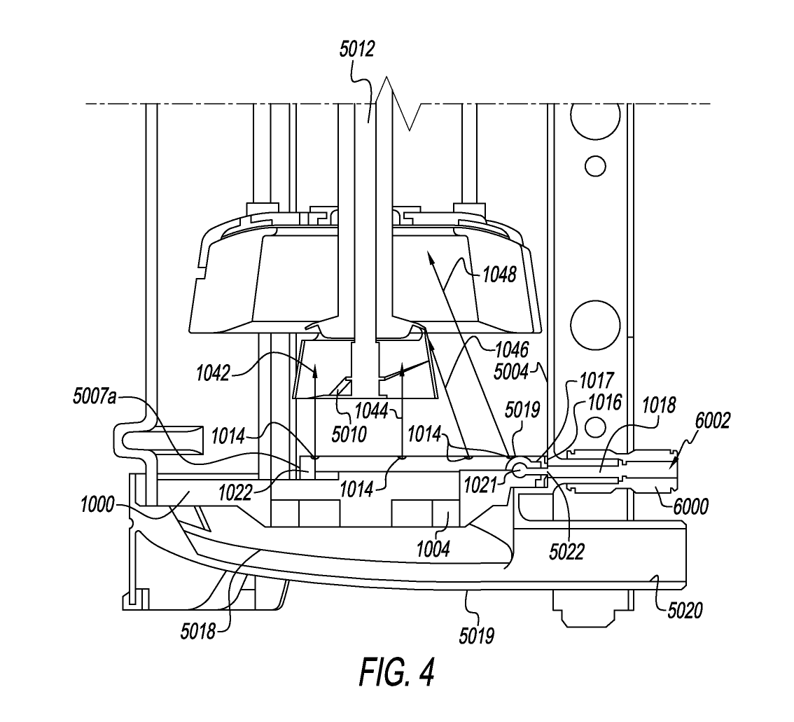

Referring to the drawings and in particular to FIG. 1, an exemplary embodiment of a rinse assembly of the present disclosure is generally referred to by 1000. Rinse assembly 1000 has a grate 1002 and a conduit 1004 formed as a one-piece structure. Grate 1002 has frame members 1006 that form openings 1008 through grate 1002. Grate 1002 has a support member 1010 that extends outward from frame members 1006. Support member 1010 is shaped complementary to a container, for example, a plastic or Styrofoam cup, in which blending of a beverage takes place. Conduit 1004 has a wall 1012 and holes 1014 through wall 1012. Conduit 1004 has a sidewall 1016 that surrounds a connection aperture (shown in FIG. 4) 1018. Sidewall 1016 is connectable to a water source. Sidewall 1016 is connected to an inlet end seal 1017. Inlet end seal 1017 is overmolded onto conduit 1004. Conduit 1004 has open ends 1020. Each of open ends 1020 is connected to one of open end seals 1022. Open end seals 1022 each have an opening so that each of open ends 1020 is not covered by open end seals 1022 and each of open ends 1020 remains open. Open ends 1020 and open end seals 1022 are identical. Alternatively, as shown in FIGS. 1A-1B, conduit 1004 is a shape that surrounds the perimeter of grate 1002 or a side wall 5004 of a blender 5000, for example a circle-like shape, said shape omitting open ends 1020 and open end seals 1022. Holes 1014 each are located around a perimeter of conduit 1004 to direct in water in predetermined directions. Pressurized water received through sidewall 1016 flows out of holes 1014 to form a spray 1011 around the perimeter of grate 1002 in the predetermined directions.

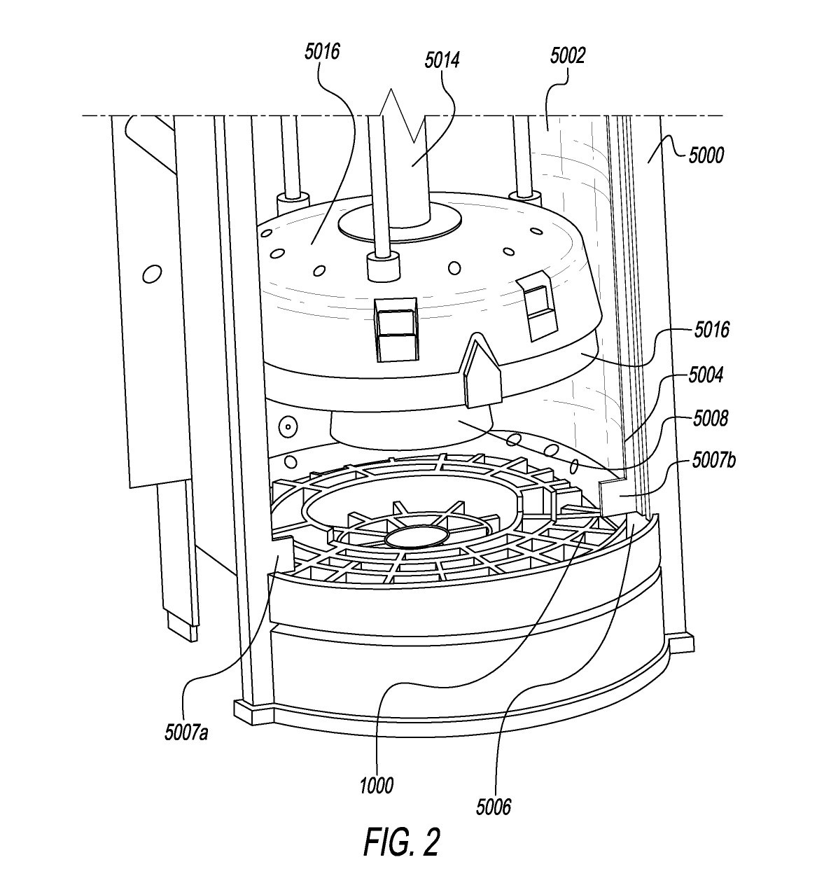

Referring to FIG. 2, rinse assembly 1000 may be incorporated into a blender 5000, for example, blender/mixer/cleaning module 303 that is a part of an assembly that dispenses and mixes beverages as described in U.S. patent application Ser. No. 12/633,790, filed Dec. 8, 2009, the contents of which are incorporated herein by reference in its entirety. Blender 5000 has a blender chamber 5002. Blender chamber 5002 has a side wall 5004 and a base wall 5006. Base wall 5006 has retaining walls 5007a and 5007b. Base wall 5006, side wall 5004 and retaining walls 5007a and 5007b have a shape that is complementary to rinse assembly 1000 so that rinse assembly 1000 is maintained in a stationary position. Blender 5000 has a blender cover 5008 that covers a blender blade 5010 (FIG. 4). Blender blade 5010 is rotated by a spindle 5012 (FIG. 4) that may be covered by a spindle cover 5014. Blender 5000 also has a container cover 5016 that covers the container in which blending of a beverage takes place.

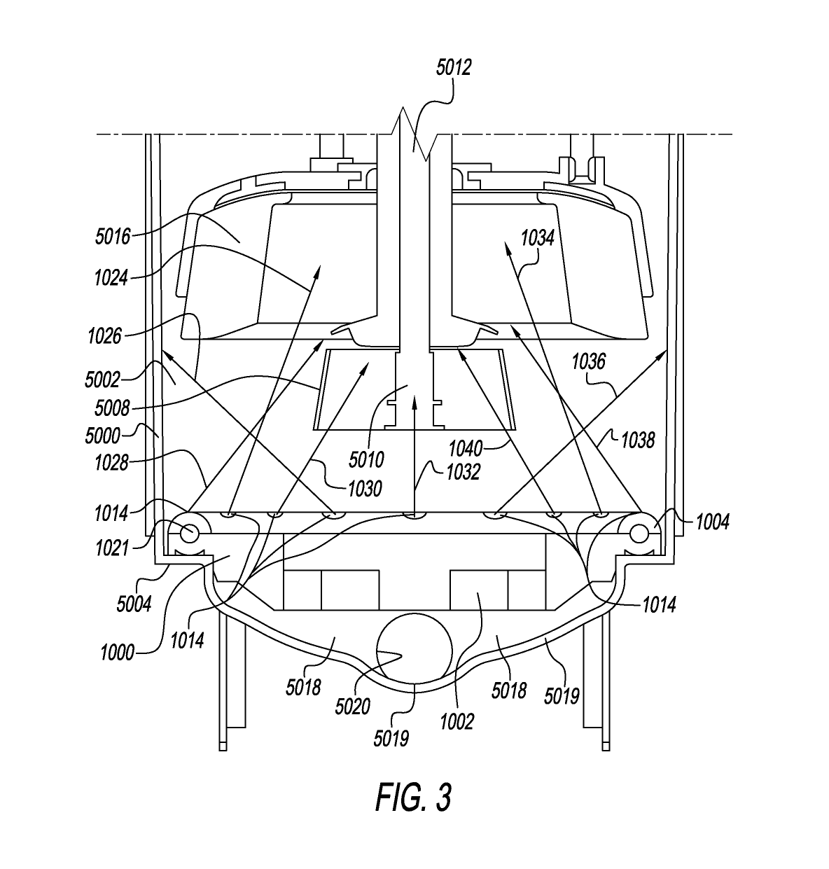

Referring to FIG. 3, in use, water is supplied under pressure to rinse assembly 1000 forming streams, as shown by arrows 1024, 1026, 1028, 1030, 1032, 1034, 1038, 1040, of water through each of holes 1014 through conduit 1004. Holes 1014 are shaped so that each of streams 1024, 1026, 1028, 1030, 1032, 1034, 1038, 1040 are directed in predetermined directions to rinse blender 5000 with water. As shown in FIG. 1, each of holes 1014 is located around a perimeter of conduit 1004 also to direct in water in predetermined directions. Holes 1014 can be shapes, such as, for example, circles, ovals, rectilinear, trapezoidal, triangular, stars. FIG. 1C shows holes 1014 having a star shape forming a spray 1011. Holes 1014 can have different or the same shapes. Streams 1024 and 1034 are directed to container cover 5016. Streams 1026 and 1036 are directed to side wall 5004. Streams 1028 and 1038 are directed to an outside of blender cover 5008. Streams 1030 and 1040 are directed to an inside of blender cover 5008. Stream 1032 is directed to blender blade 5010. The water falls through grate 1002 by gravity into a sump cavity 5018 formed by a sump wall 5019. Sump cavity 5018 is connected to a drain pipe 5020 of blend chamber 5002 to drain water from blender 5000. The water may be mixed with sanitizer. Alternatively, streams, as shown by arrows 1024, 1026, 1028, 1030, 1032, 1034, 1038, 1040, of water through each of holes 1014 through conduit 1004 can be pulsed and not a continuous flow. A pump or modulator can pulse the flow of water through each of holes 1014 through conduit 1004. Another alternative, streams, as shown by arrows 1024, 1026, 1028, 1030, 1032, 1034, 1038, 1040, of water through each of holes 1014 through conduit 1004 can use a combination of water and air from a source of pressurized air. The water can also include cleaning or sanitizing fluid.

Referring to FIG. 4, when rinse assembly 1000 is in place in blend chamber 5002, inlet end seal 1017 contacts side wall 5004 to align connection aperture 1018 and an inlet opening 5022 through side wall 5004. Inlet opening 5022 communicates with water source tubing 6000 to provide a flow of water, as shown by arrow 6002, through inlet aperture 5022 and connection aperture 1018 into passage 1021 of conduit 1004. Passage 1021 is continuous between open ends 1020. When rinse assembly 1000 is in place in blend chamber 1002, each of open end seals 1022 contacts one of retaining walls 5007a and 5007b forming a seal between each of open end seals 1022 and one of retaining walls 5007a and 5007b closing open ends 1020 so that water flows through holes 1014 out of conduit 1004. Conduit 1004 may form additional streams 1042, 1044, 1046 and 1048 through holes 1014.

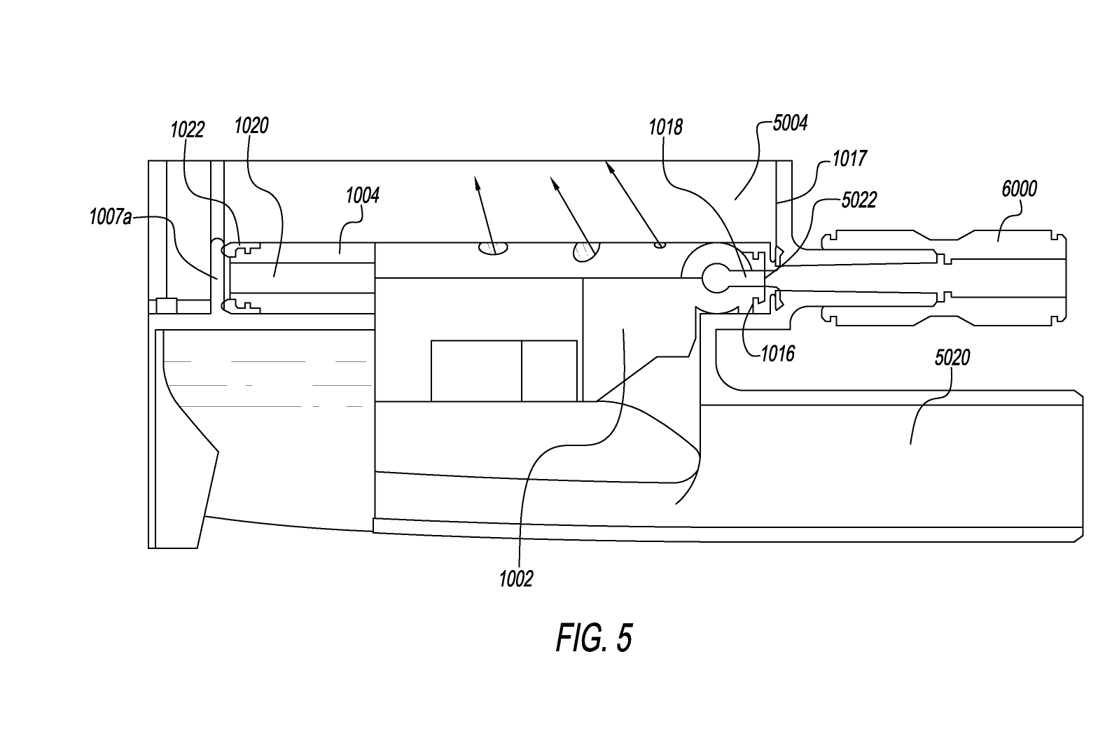

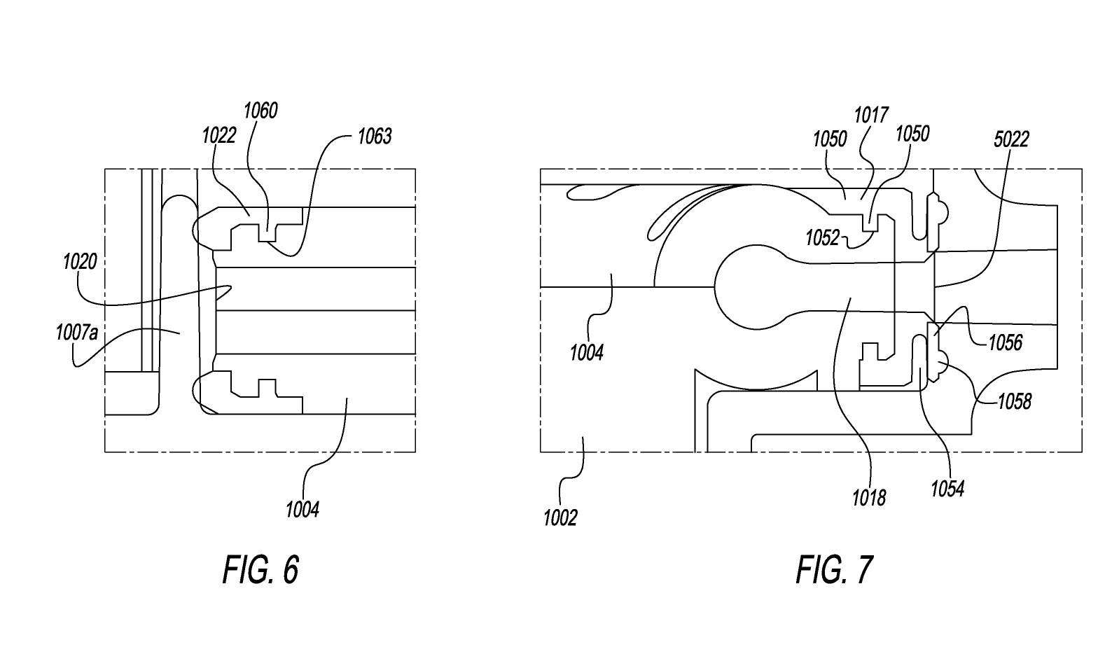

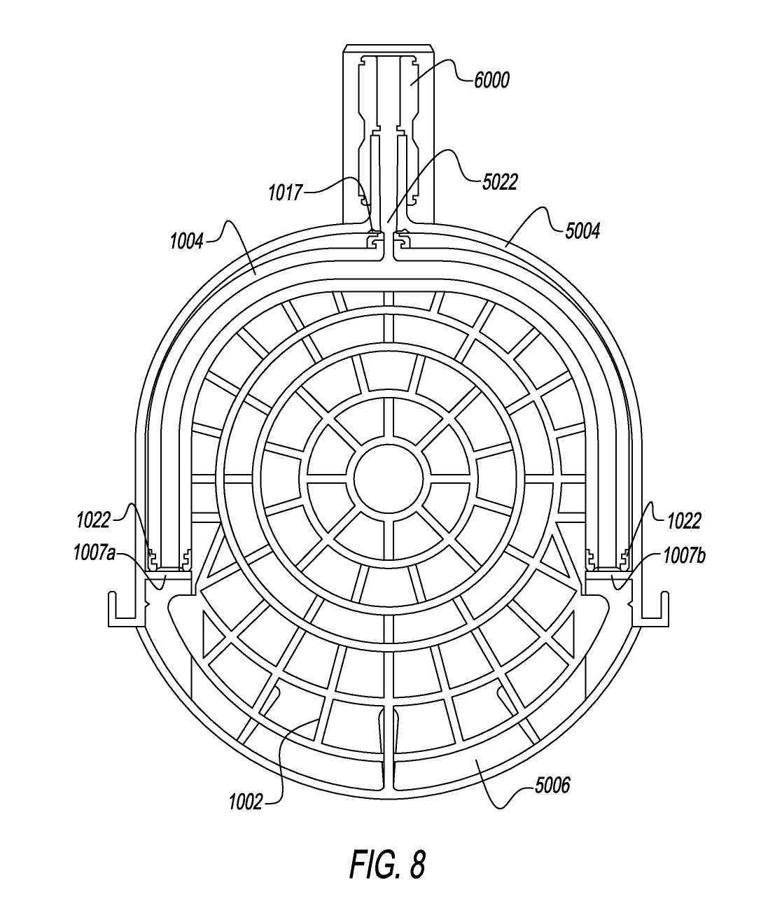

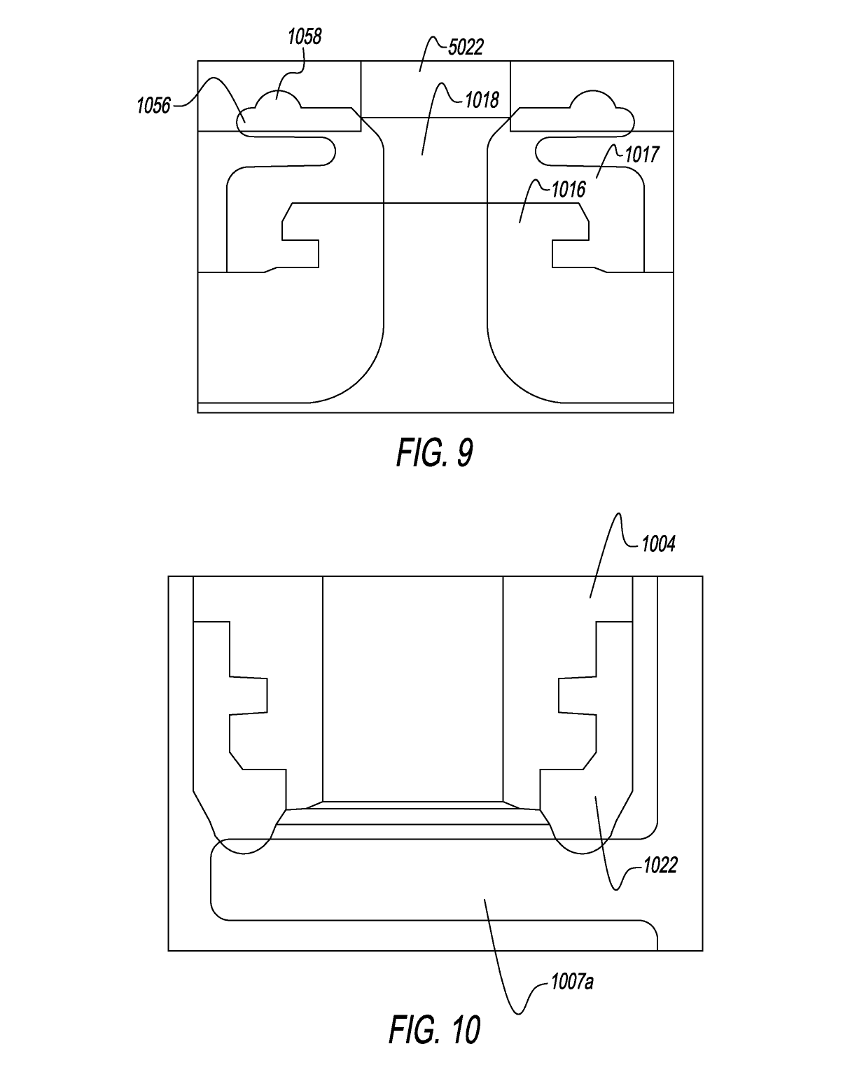

Referring to FIGS. 5-10, inlet end seal 1017 and one of open end seals 1022 are shown in pre-state manufactured position when rinse assembly 1000 is not positioned in blender. However, inlet end seal 1017 and open end seals 1022 will be compressed so that inlet end seal 1017 contacts side wall 5004 and open end seals 1022 contact one of retaining walls 5007a and 5007b when in place in blender 5000. Inlet end seal 1017 has a protrusion 1050 that fits in groove 1052 in side wall 1016 connecting inlet end seal 1017 to side wall 1016. Inlet end seal 1017 may be removable from side wall 1016. Inlet end seal 1017 has a groove 1054 forming a fold 1056. Fold 1056 is moved toward side wall 1016 when inlet end seal 1017 is compressed. Fold 1056 has a ridge 1058 that may be urged against side wall 5004 when inlet end seal 1017 is compressed. Open end seals 1022 each has a protrusion 1060 that fits in groove 1063 in conduit 1004 connecting open end seals 1022 to conduit 1004. Open end seals 1022 may be removable from conduit 1004.

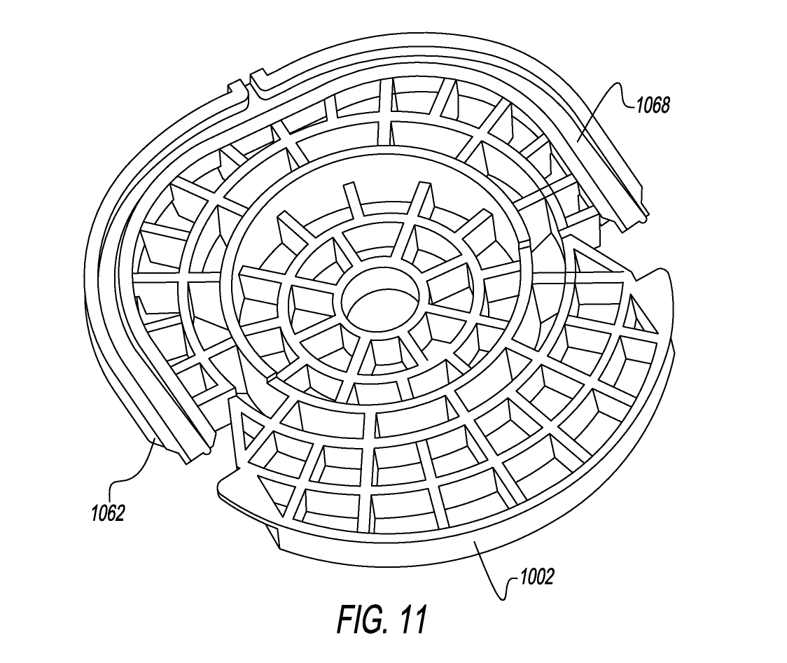

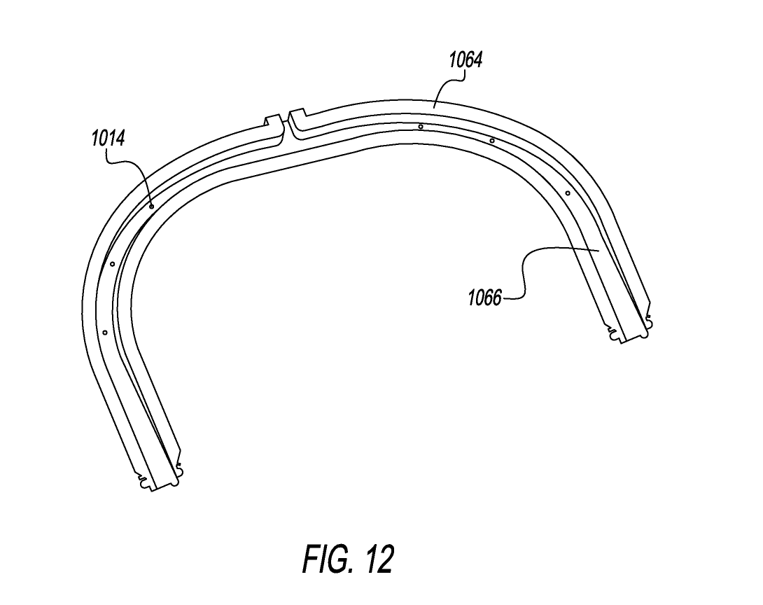

Referring to FIGS. 11-12, rinse assembly 1000 has a lower portion 1062 and an upper portion 1064. Upper portion 1064 has a channel 1066 and lower portion 1062 has a channel 1068. Upper portion 1064 and lower portion 1062 are connected to form conduit 1004. When upper portion 1064 and lower portion 1062 are connected, channels 1066 and 1068 are aligned to form passage 1021. Lower portion 1062 is connected to upper portion 1064, for example, by snap fit, adhesive, molding, and/or thermoplastic welding such as ultrasonic welding, hot plate welding, vibration welding, etc.

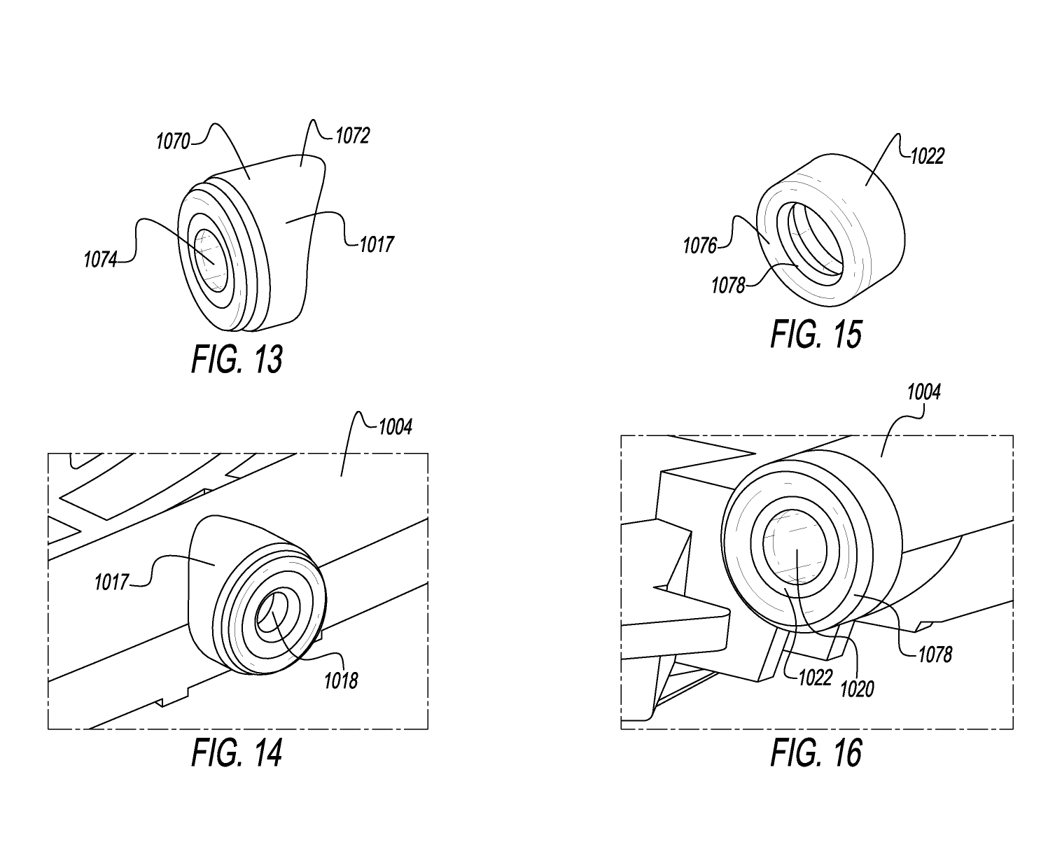

Referring to FIGS. 13-14, inlet end seal 1017 has a side portion 1070 that surrounds side wall 1016. Side portion 1070 is shaped to extend beyond side wall 1016 on a top portion 1072. Inlet end seal 1017 has an interior wall 1074 that extends into connection aperture 1018. Inlet end seal 1017 is made of a material, for example, plastic such as thermoplastic elastomer, or natural rubber. Inlet end seal 1017 may be overmolded onto side wall 1016 or manufactured as a separate part and assembled onto side wall 1016.

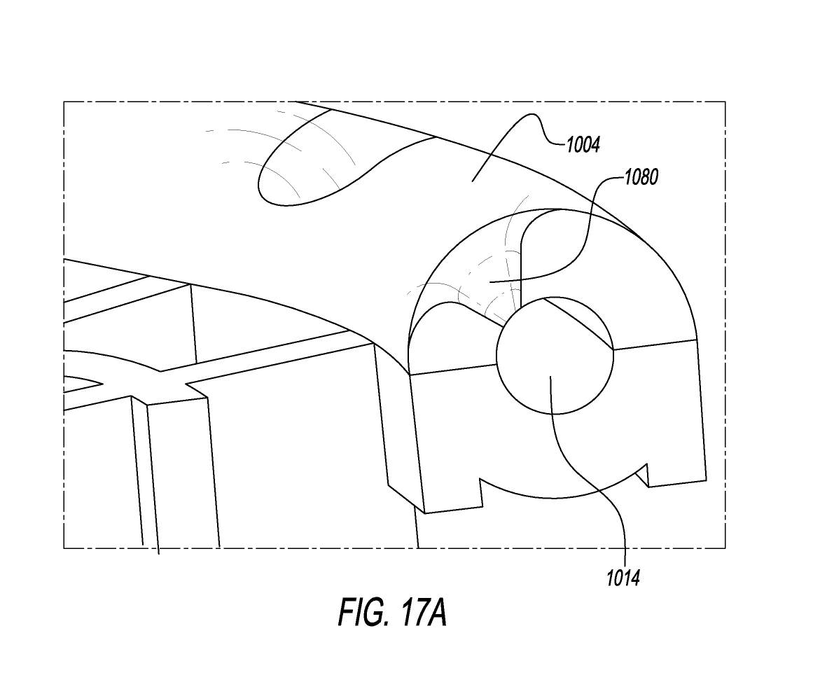

Referring to FIGS. 15-16, open end seals 1022 each have a forward portion 1076 that extends away from conduit 1004. Front portion 1076 has an aperture 1078 that is wider than open ends 1020. Open end seals 1022 are made of a material, for example, plastic such as thermoplastic elastomer, or rubber. Open end seals 1022 may be overmolded onto conduit 1004 or manufactured as a separate part and assembled onto conduit 1004.

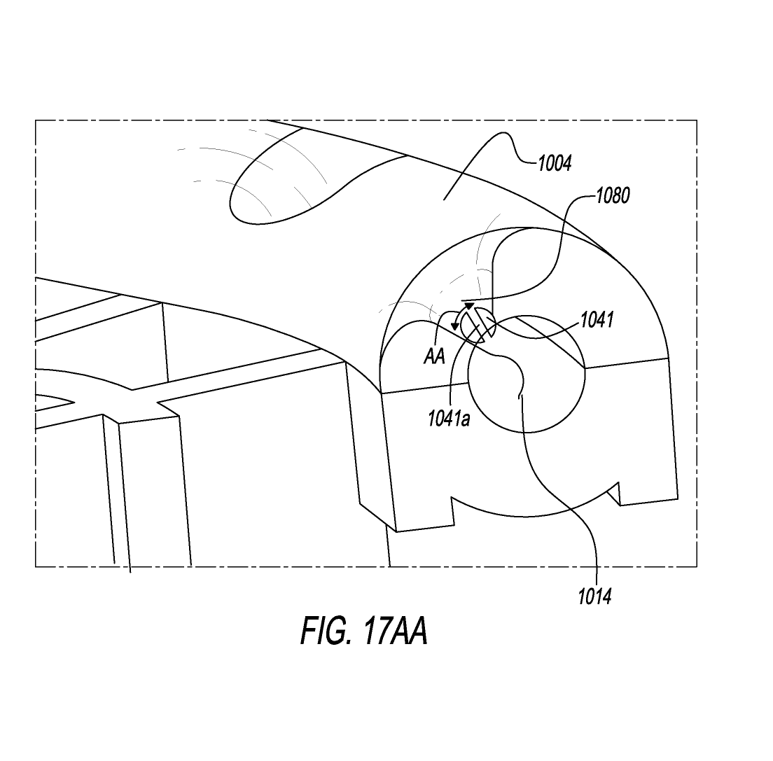

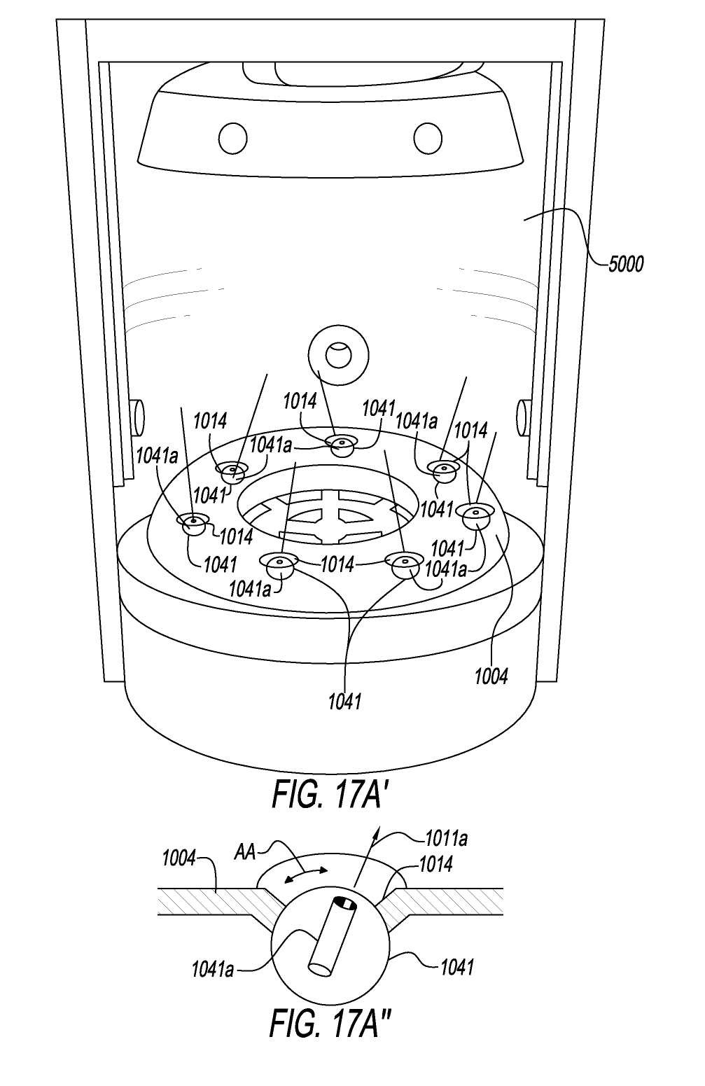

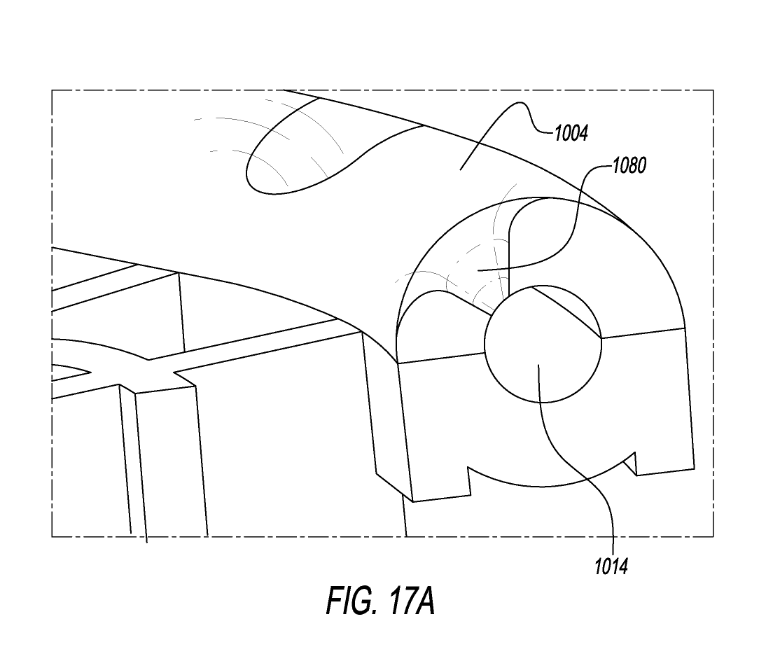

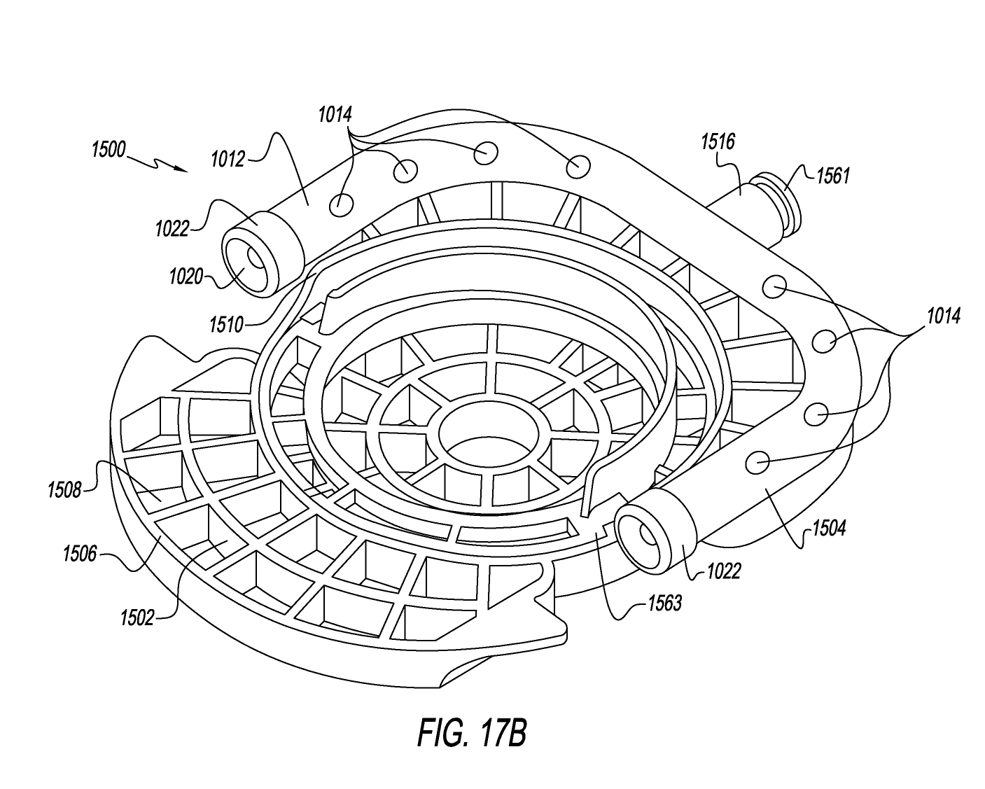

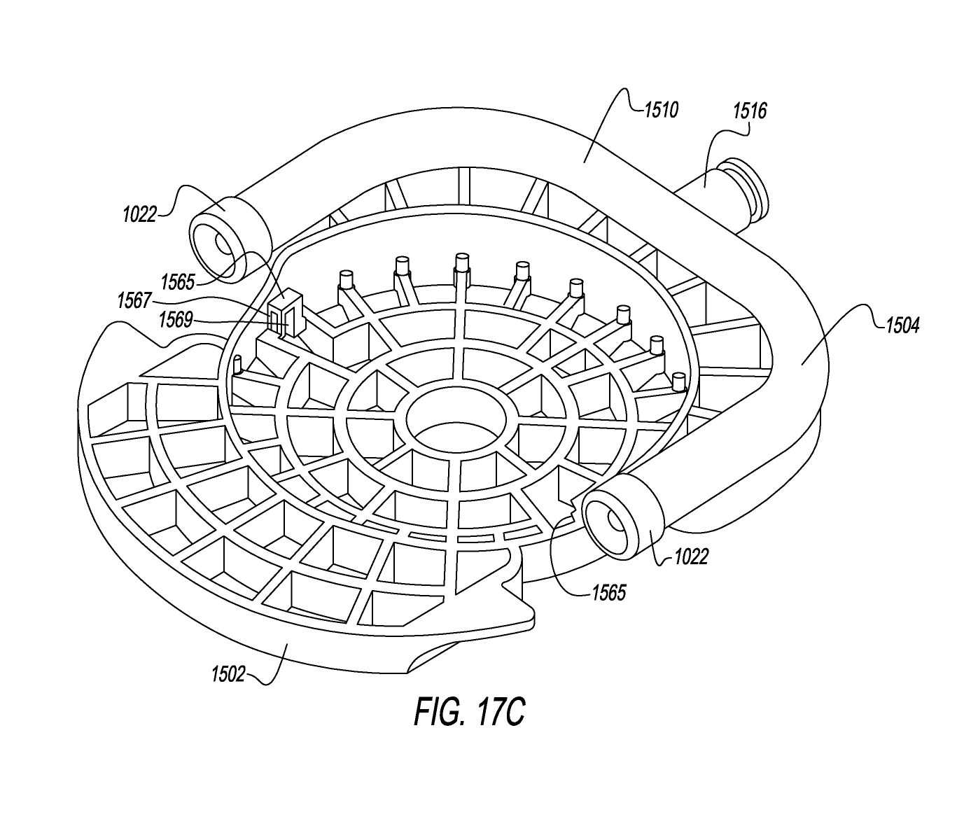

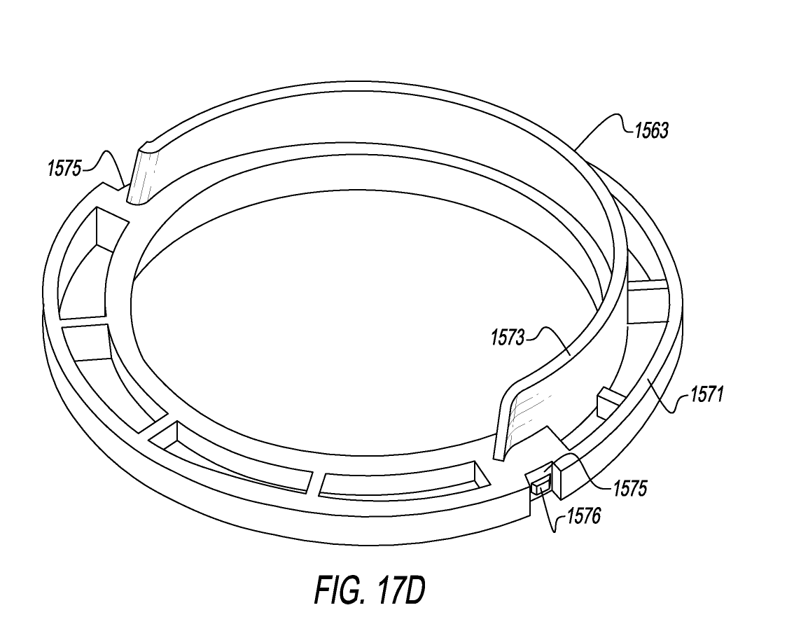

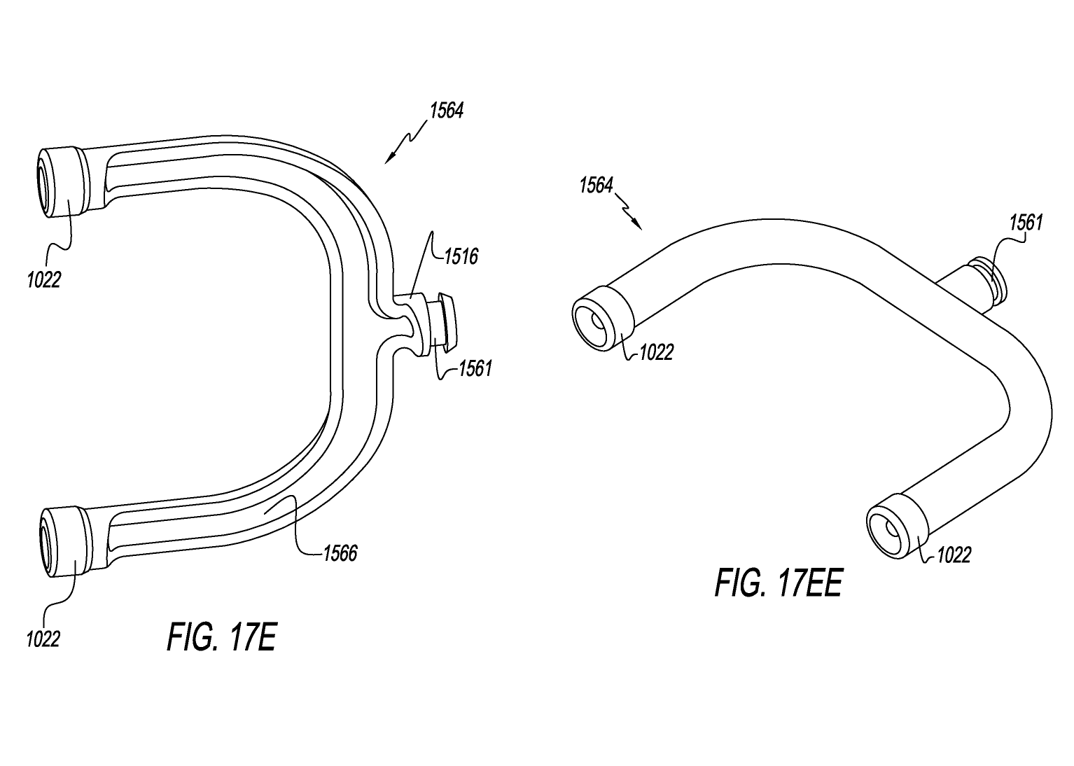

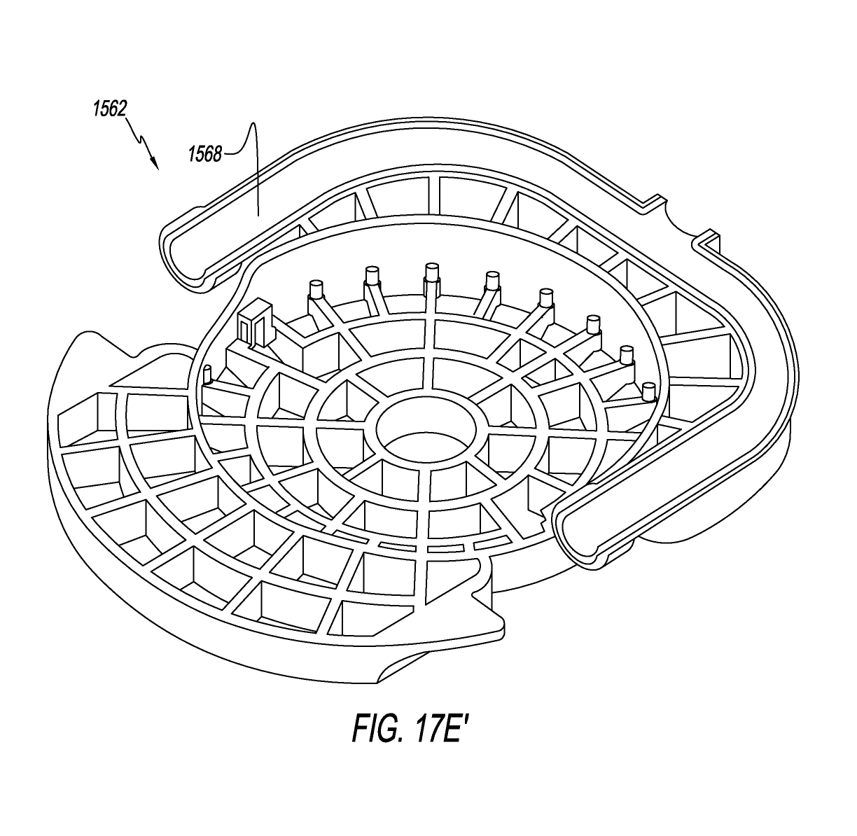

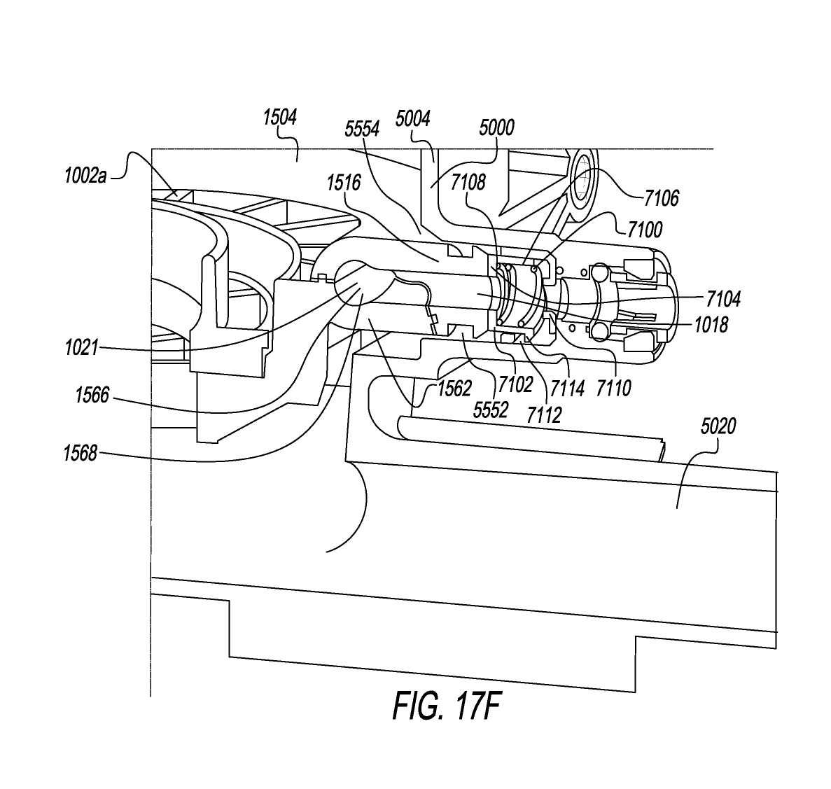

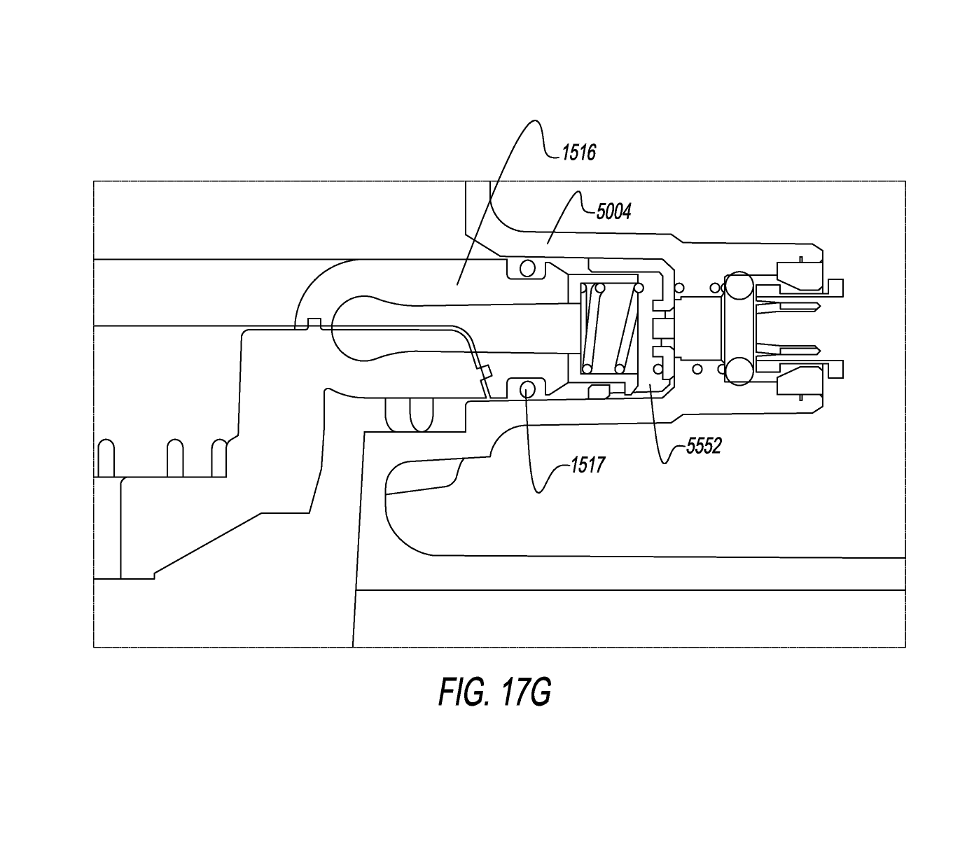

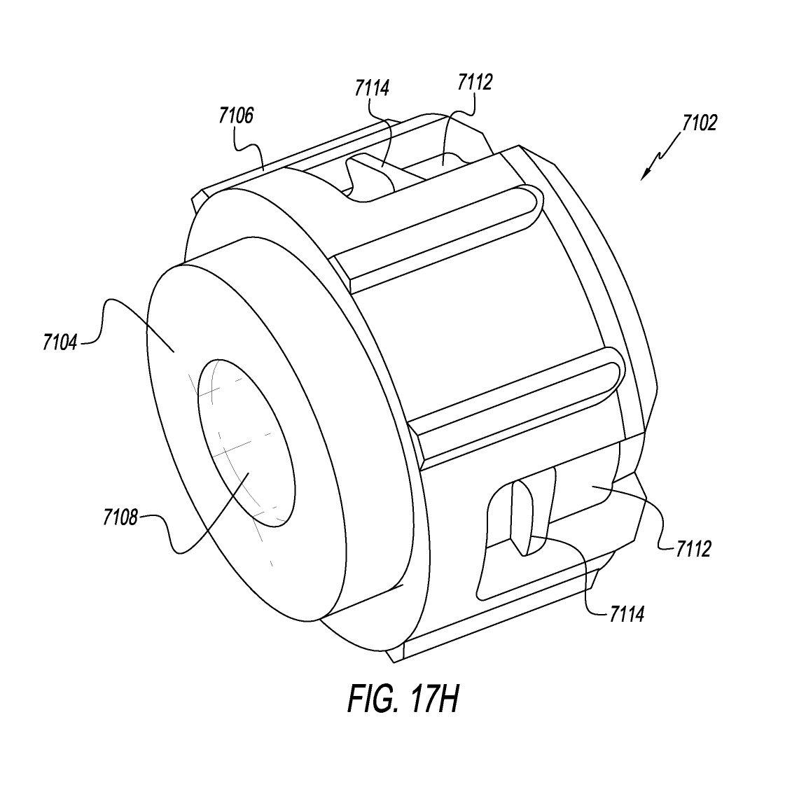

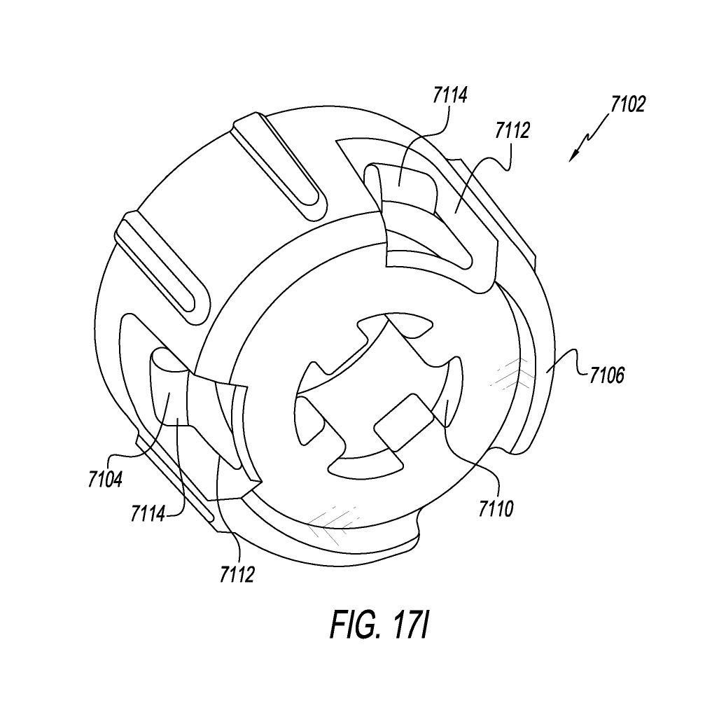

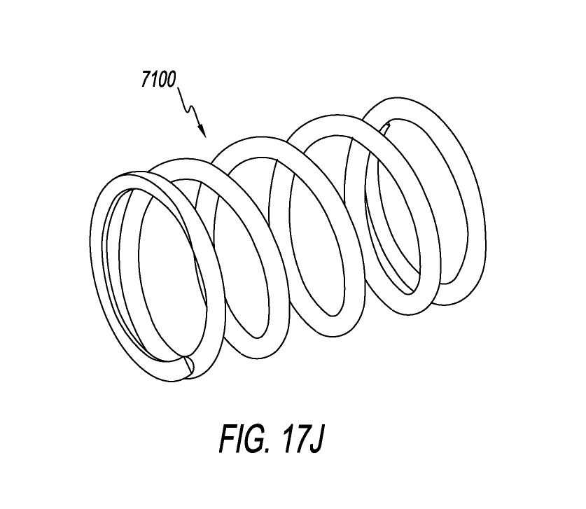

Referring to FIG. 17A, a portion 1080 of conduit 1004 surrounding each of holes 1014 is shaped to direct water that passes through holes 1014 in predetermined directions. For example, a conical shape may surround each of holes 1014. Each of holes 1014 is located on conduit 1004, e.g., closer to grate 1002 or further from grate 1002, to direct in water in predetermined directions. Alternatively, as shown in FIGS. 17AA-17A″, each of holes 1014 has an adjustable jet. The adjustable jet, for example, has an adjustable body 1041 that is generally spherical in shape having an orifice 1041a through adjustable body 1041. Adjustable body 1041 can be moved, for example, along arrow AA, by placing a tool or pin inside of orifice 1041a and applying a pressure in the desirable direction moving adjustable body 1041 until orifice 1041a is positioned in a desired position so that pressurized water through orifice 1041a form a spray in a desired direction as shown by arrow 1011a. Adjustable body 1041 may connect to conduit 1004 inside of one or more of holes 1014 by friction or snap fit forming a ball and socket connection. Alternatively, conduit 1004 may be a hollow annulus that distributes water to holes 1014.

To further enable a rinsing operation the container in which blending takes place needs to be separated from blender chamber 5002 with grate 1002. Grate 1002 suspends the container in which blending takes place in space sufficiently to provide a sump cavity 1002 in the blender chamber 5002. In addition to suspending the container in which blending takes place above the sump cavity 5018, grate 1002 must also robustly handle a reaction loading that occurs during a blending operation. Grate 5018 is made of a material, for example, thermoplastic. Rinse assembly 1000 integrates grate 1002 with rinsing components such as conduit 1004. Integrating conduit 1004 with grate 1002 aligns and levels conduit 1004 in blender chamber 5002 upon placement of grate 1002 in blender chamber increasing ease of installation of conduit 1004. The one-piece structure of grate 1002 and conduit 1004 decreases cost over separate grates and conduits and permits rinse assembly 1000 to be moldable. Molding rinse assembly 1000 decreases or eliminates inconsistencies created by second tooling, for example, if there was a need for drilling holes 1014. Rinse assembly 1000 may be used with a pressure booster.

The integration of rinsing feature and cup structural placement feature is achieved by rinse assembly 1000. Rinse assembly 1000 can be easily removed by customer for daily/weekly cleaning operation(s). Once rinse assembly 1000 is removed blender chamber 5002 can be thoroughly cleaned while in place in the blender. While rinse assembly 1000 is removed rinse assembly 1000 can be placed into bucket of cleaning solution to soak. Rinse assembly 1000 enables conduit 1004 to be cleaned with a nylon brush between open ends 1020. There is one continuous passage 1021 that can be cleaned with the nylon brush.

Referring to FIG. 17B, an alternative embodiment of a rinse assembly is shown and generally referred to by 1500. Rinse assembly 1500 is similar to rinse assembly 1000. Features that are the same in rinse assembly 1500 and rinse assembly 1000 are referred to by the same reference numerals. Rinse assembly 1500 has side wall 1516 of conduit 1504. Side wall 1516 has a groove 1561.

Rinse assembly 1500 has a grate 1502 with frame members 1506 that form openings 1508 through grate 1002. Grate 1502 has a grate support member 1510 that extends outward from frame members 1506. Grate support member 1510 is shaped complementary to a container, for example, a plastic or Styrofoam cup, in which blending of a beverage takes place, or to fit an insert 1563. Insert 1563 can be removable from grate 1502. Insert 1563 may fit in grate support member 1510 to rest on frame members 1506 by gravity or be secured to frame members 1506, for example, by friction fit or snap fit. Insert 1563 is shaped complementary to a container, for example, a plastic or Styrofoam cup.

Referring to FIG. 17C, grate 1502 has connectors 1565. Each of connectors 1565 has an outer frame 1567 and a frame opening 1569.

Referring to FIG. 17D, insert 1563 has an outer member 1571. Outer member 1571 is shaped complementary to grate support member 1510 so that insert 1563 fits in grate support member 1510. Insert 1563 has an insert support member 1573. Insert support member 1573 is shaped complementary to a container, for example, a plastic or Styrofoam cup, in which blending takes place. Insert 1563 has indentations 1575 that are sized to each receive outer frame 1567 of one of connectors 1565 to maintain insert 1563 in place in grate support member 1510. Insert 1563 has protrusions 1576 that each fit in one of frame openings 1569. Grate 1502 may be used with different rings 1563 that each has a different ring support member 1573 to support a different sized container. The different inserts 1563 each has the same outer member 1571 to each fit in grate support member 1510. Insert 1563 provides centering alignment of the container, e.g., cup, in the blender 5000. Insert 1563 is custom to each customer and is easily removed and snapped into place so that another cup insert of different size for a different customer may be used.

Referring to FIGS. 17E, 17EE and 17E′, rinse assembly 1500 has a lower portion 1562 (FIGS. 17E′ and 17F) and an upper portion 1564 (FIGS. 17E and 17EE). Upper portion 1564 has a channel 1566 and lower portion 1562 has a channel 1568. Upper portion 1564 and lower portion 1562 are connected to form conduit 1504. When upper portion 1564 and lower portion 1562 are connected, channels 1566 and 1568 are aligned to form passage 1021. Lower portion 1562 is connected to upper portion 1564, for example, by snap fit, adhesive, molding and/or thermoplastic welding such as ultrasonic welding, hot plate welding, vibration welding, etc. Upper portion 1564 has open end seals 1022 and groove 1561 so that all of the seal geometry is on upper portion 1564. Groove 1561 is sized to receive an o-ring seal so that a seal is not overmolded onto side wall 1516.

Referring to FIG. 17F, side wall 5004 of blender 5000 forms a cavity 5552 accessed by a cavity opening 5554. Cavity 5552 is sized to receive sidewall 1516. A spring 7100, as shown in FIG. 17J, is between side wall 1516 of rinse assembly 1500 and side wall 5004 of blender 5000 in cavity 5552. Spring 7100 is shown in pre-state manufactured position when rinse assembly 1500 is not positioned in blender. However, spring 7100 will be compressed between side wall 1516 and side wall 5004 of blender 5000 when in place in blender 5000. Spring 7100 provides compression to open end seals 1022 against retaining walls 5007a and 5007b when rinse assembly 1500 is in blender 5000. As shown in FIGS. 17H and 17I, spring 7100 may be housed in spring keeper assembly 7102. Spring keeper assembly 7102 has a downstream portion 7104 and an upstream portion 7106. Downstream portion 7104 abuts side wall 1516 and has an opening 7108 that aligns with connection aperture 1018. Cavity 5552 narrows in size adjacent upstream portion 7106 so that upstream portion 7106 abuts side wall 5004 of blender 5000 in cavity 5552. Upstream portion 7106 has an opening 7110 that aligns with opening 7108 and connection aperture 1018 so that water may pass therethrough. Downstream portion 7104 fits in upstream portion 7106. Spring 7100 urges upstream portion 7106 and downstream portion 7104 apart. Upstream portion 7106 has one or more apertures 7112. Downstream portion 7104 has one or more ridges 7114 that fit in apertures 7110 to maintain a connection between upstream portion 7106 and downstream portion 7104.

Referring to FIG. 17G, cavity 5552 is sized to receive sidewall 1516 so that a side wall seal 1517 is between sidewall 1516 and side wall 5004 in cavity 5552. Side wall seal 1517 is an o-ring seal forming a radial hydraulic seal.

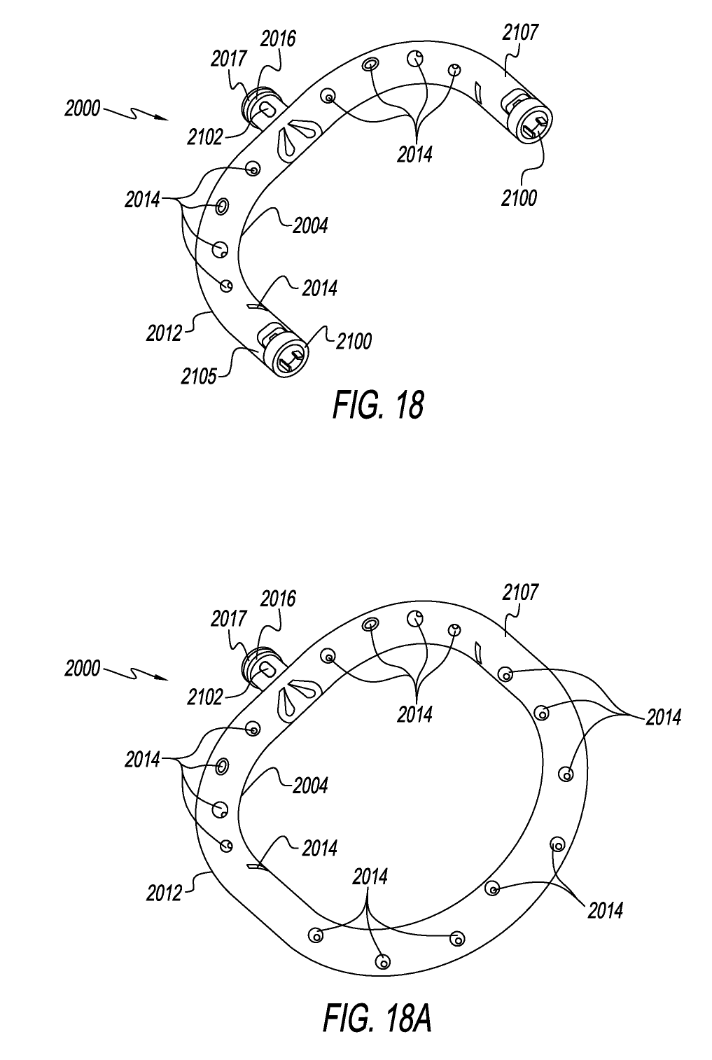

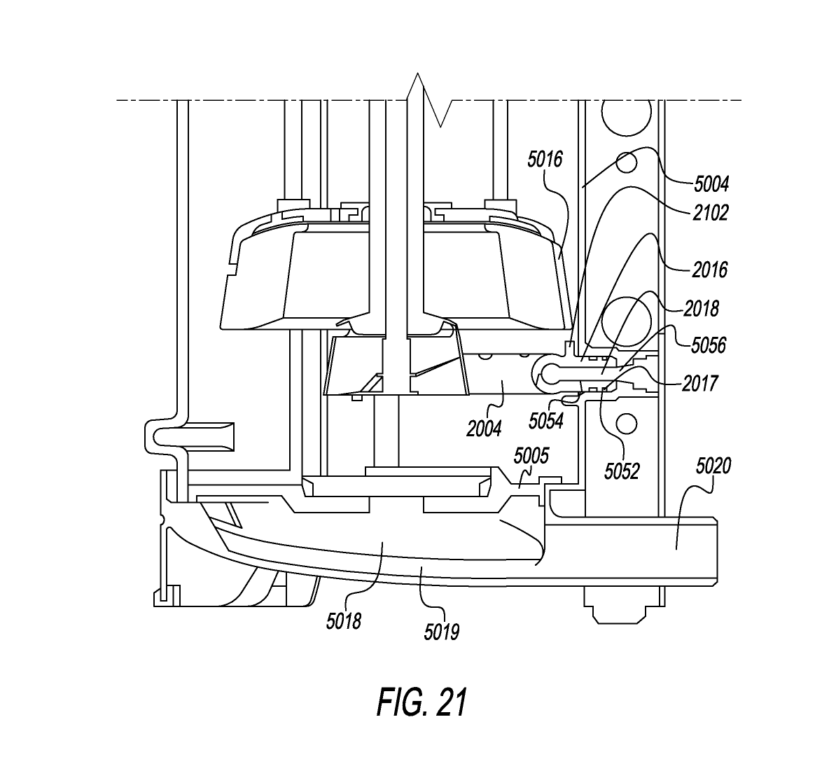

Referring to FIG. 18, a second embodiment of a rinse assembly of the present disclosure is generally referred to by 2000. Features of rinse assembly 2000 that are the same as rinse assembly 1000 have the same reference numerals. Rinse assembly 2000 has a conduit 2004. Conduit 2004 has caps 2100 connected to ends 2105 and 2107 of conduit 2004. Ends 2105 and 2107 have conduit openings 2116 and 2118, as shown in FIG. 29. Caps 2100 closed ends 2105 and 2107 of conduit 2004. Conduit 2004 has a wall 2012 and holes 2014 through wall 2012. Conduit 2004 has a sidewall 2016 that surrounds a connection aperture (shown in FIG. 21) 2018. Sidewall 2016 is connectable to a water source. Sidewall 2016 is connected to an inlet end seal 2017, for example, an o-ring seal. Conduit 2004 has a protuberance 2102 extending outward from sidewall 2016. Alternatively, as shown in FIG. 18A, conduit 2004 is a circle shape omitting conduit openings 2116 and 2118 and caps 2100.

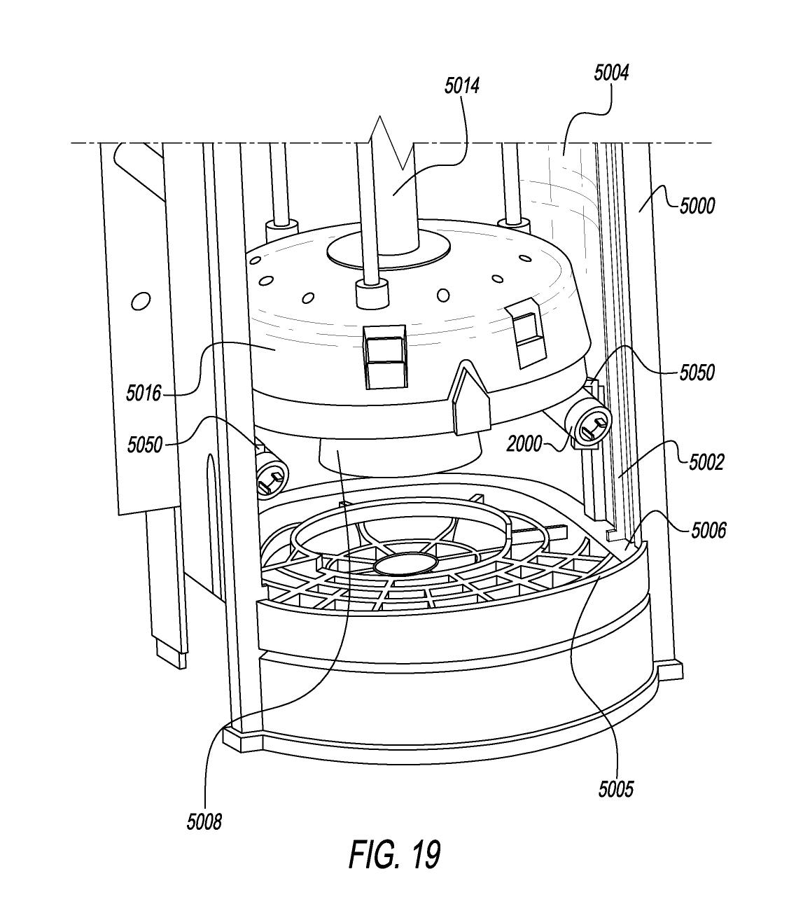

Referring to FIG. 19, rinse assembly 2000 may be incorporated into a blender 5000, for example, blender/mixer/cleaning module 303 that is a part of an assembly that dispenses and mixes beverages as described in U.S. patent application Ser. No. 12/633,790, filed Dec. 8, 2009, the contents of which are incorporated herein by reference in its entirety. Blender 5000 has base wall 5006 with a grate 5005 that is separate from rinse assembly 2000. Side wall 5004 has brackets 5050 that each attach to conduit 2004 by snap fit.

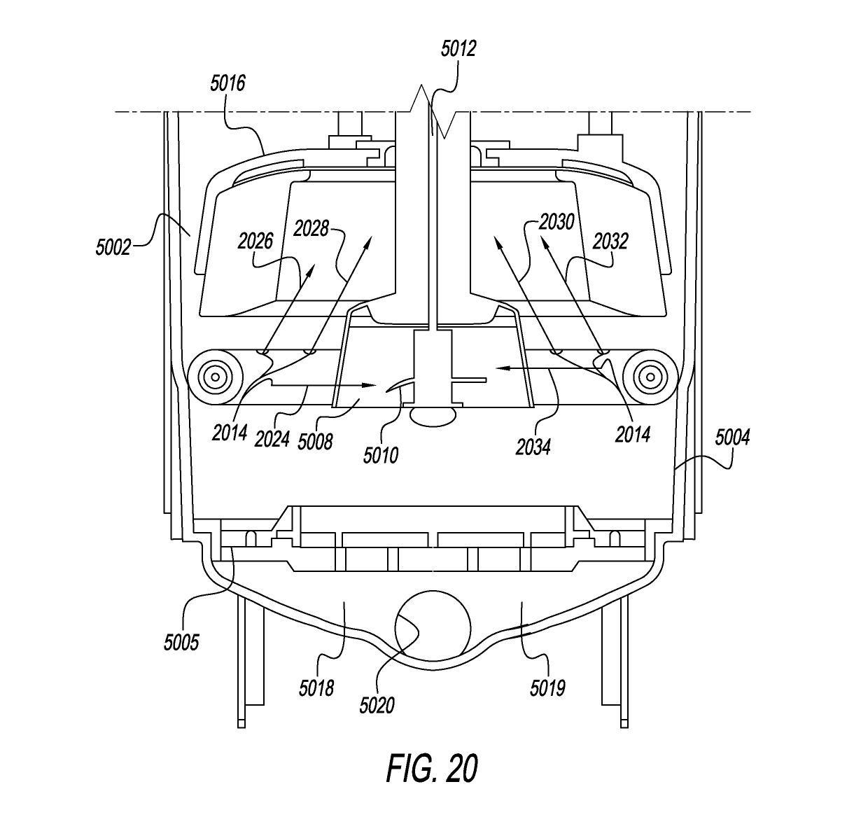

Referring to FIG. 20, in use, conduit is connected to blend chamber 5002. At least a portion of conduit 2004 contacts side wall 5004 of blend chamber 5002. Water is supplied under pressure to rinse assembly 2000 forming streams, as shown by arrows 2024, 2026, 2028, 2030, 2032, 2034, of water through each of holes 2014 through conduit 2004. Holes 2014 are shaped and located so that each of streams 2024, 2026, 2028, 2030, 2032, 2034 are directed in predetermined directions to rinse blender 5000 with water. Streams 2026, 2028, 2030, 2032, are directed to container cover 5016. Streams 2024 and 2034 are directed to blender cover 5008. Holes 2014 can be shapes, such as, for example, circles, ovals, rectilinear, trapezoidal, triangular, stars. Holes 2014 can have different or the same shapes. The water falls through grate 5005 by gravity into sump cavity 5018 of formed by sump wall 5019. Sump cavity 5018 is connected to drain pipe 5020 of blend chamber 5002 to drain water from blender 5000. The water may be mixed with sanitizer. Alternatively, streams, as shown by arrows 2024, 2026, 2028, 2030, 2032, 2034, of water through each of holes 2014 through conduit 2004 can be pulsed and not a continuous flow. A pump or modulator can pulse the flow of water through each of holes 2014 through conduit 2004. Another alternative, streams, as shown by arrows 2024, 2026, 2028, 2030, 2032, 2034, of water through each of holes 2014 through conduit 2004 can use a combination of water and air from a source of pressurized air. The water can also include cleaning or sanitizing fluid.

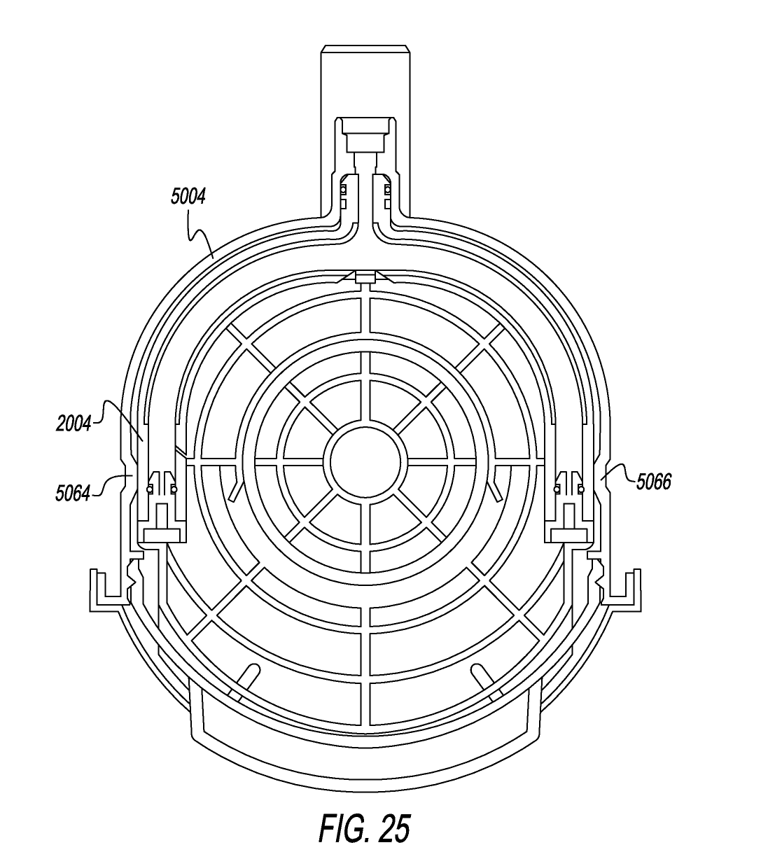

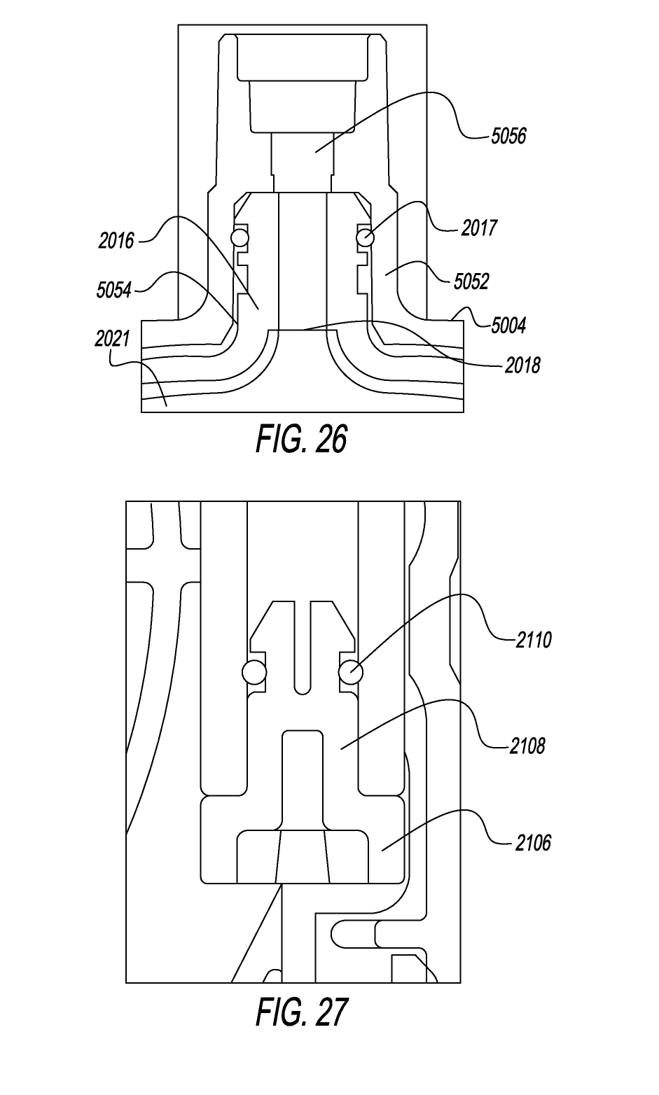

Referring to FIGS. 21, 24 and 26, side wall 5004 forms a cavity 5052 accessed by a cavity opening 5054. Cavity 5052 is sized to receive sidewall 2016 so that inlet end seal 2017 forms a seal between sidewall 2016 and side wall 5004 in cavity 5052. Protuberance 2102 contacts side wall 5004 to limit movement of side wall 2016 into cavity 5052. Surface of side wall 5004 forming cavity 5052 supports conduit 2004. When rinse assembly 2000 is in place in blender chamber 5002, inlet end seal 2017 contacts side wall 5004 to align connection aperture 2018 and an aperture 5056 through side wall 5004. Aperture 5056 communicates with a water source to provide a flow of water through aperture 5056 and connection aperture 2018 into a passage 2021 of conduit 2004. Passage 2021 is continuous between ends 2105 and 2107 of conduit 2004. Alternatively, brackets 5050 may be omitted, and conduit 2004 may be connected to blender chamber by connection of sidewall 2016 and side wall 5004 in cavity 5052.

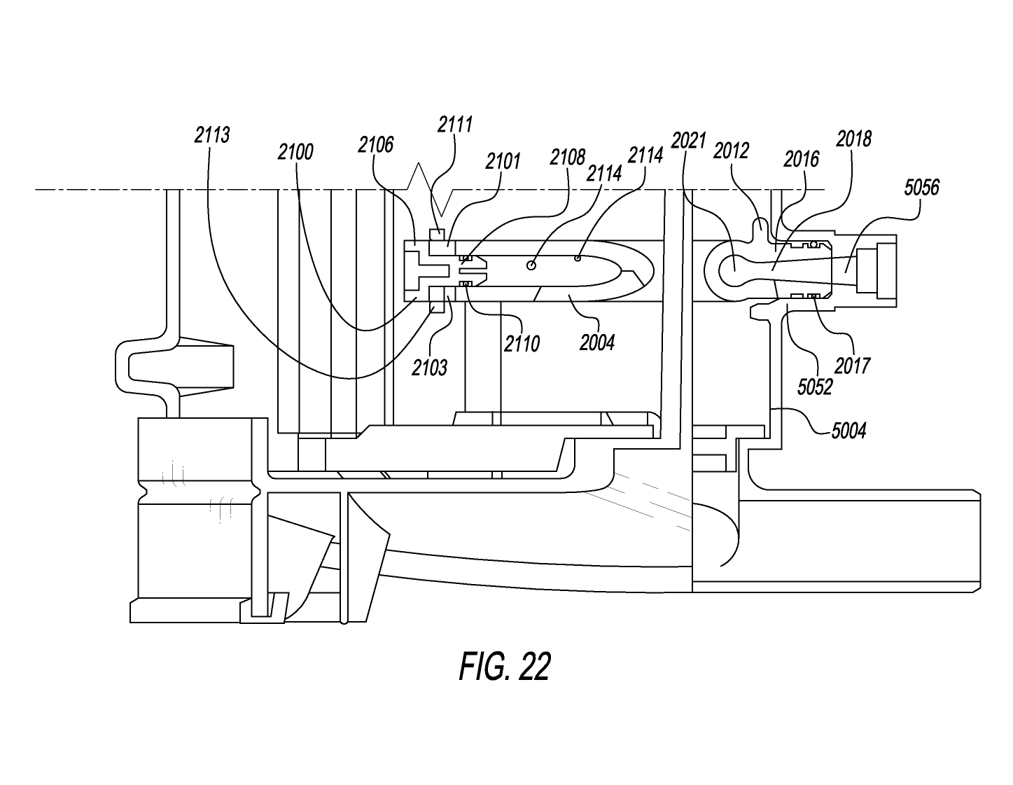

Referring to FIGS. 22 and 27, conduit 2004 has two conduit apertures 2101 and 2103 adjacent two end walls 2111 and 2113 that extend outward from passage 2021. Caps 2100 are identical. Each of end caps 2100 has a cover portion 2106 and connection portion 2108. Cover portion 2106 is sized to enclose ends 2105 and 2107. Connection portion 2108 fits in conduit 2004. A cap seal 2110 is between connection portion 2108 and conduit 2004 forming a seal between connection portion 2108 and conduit 2004. The seal is between connection portion 2108 and conduit 2004 so that water passes through sidewall 2016 through passage 2021 and out of holes 2014 forming streams 2024, 2026, 2028, 2030, 2032, 2034. Cover portion 2106 of each of caps 2100 is adjacent end walls 2111 and 2113 of conduit 2004 when caps 2100 are connected to conduit 2004.

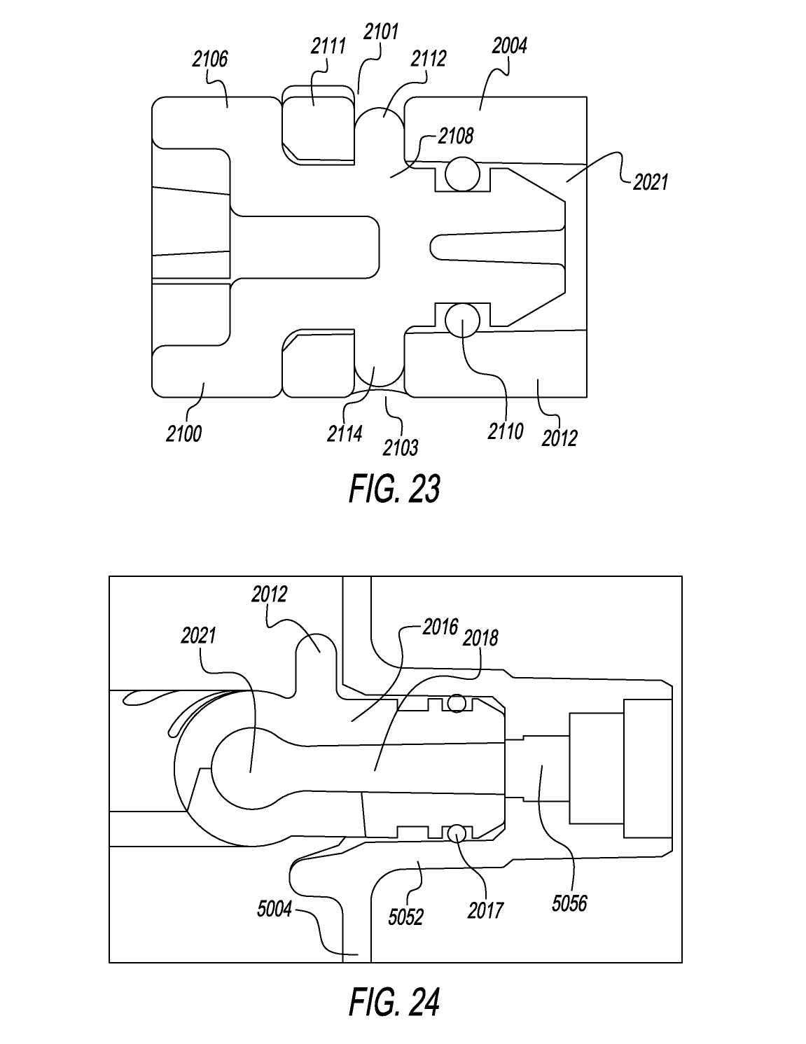

Referring to FIG. 23, caps 2100 have two protrusions 2112 and 2114. Each of protrusions 2112 and 2114 fits through one of conduit apertures 2101 and 2103 through conduit 2004. Alternatively, wall 2012 of conduit 2004 may be continuous having depressions in passage 2021 that receive protrusions 2112 and 2114 instead of protrusions 2112 and 2114 passing through conduit apertures 2101.

Referring to FIG. 25, side wall 5004 may have protruding portions 5064 and 5066 that abut conduit 2004. Protruding portions 5064 and 5066 support conduit 2004 to maintain conduit 2004 in place in blender chamber 5002.

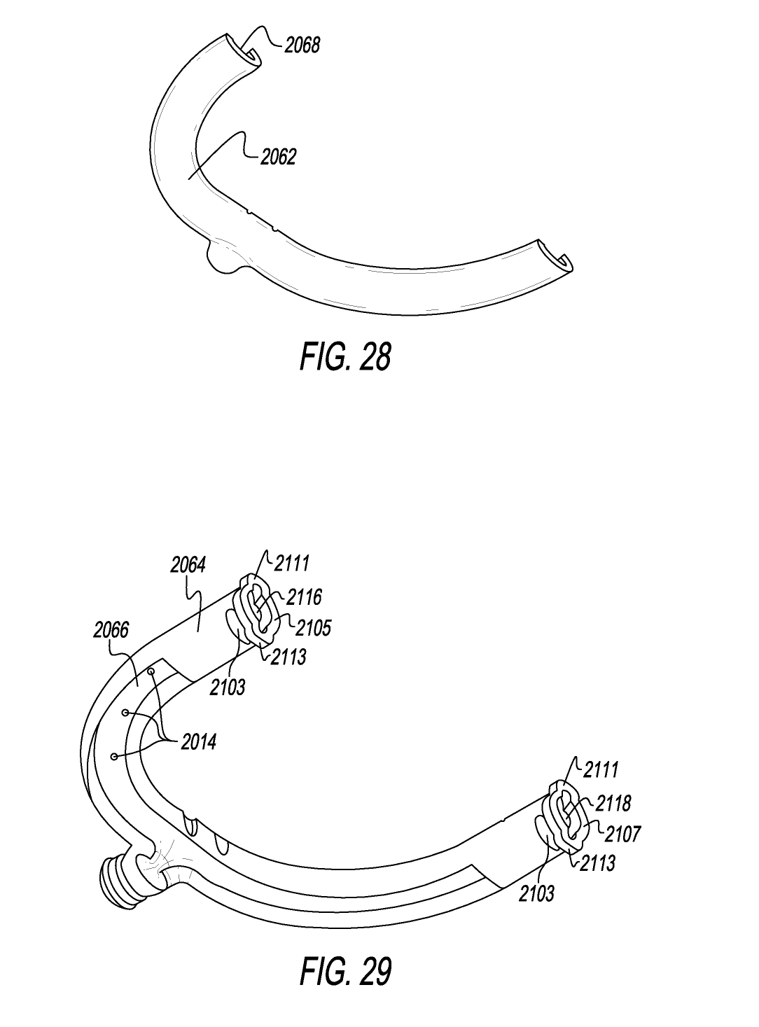

Referring to FIGS. 28-29, rinse assembly 2000 has a lower portion 2062 and an upper portion 2064. Upper portion 2064 has a channel 2066 and lower portion 2062 has a channel 2068. Upper portion 2064 and lower portion 2062 are connected to form conduit 2004. When upper portion 2064 and lower portion 2062 are connected, channels 2066 and 2068 are aligned to form passage 2021.

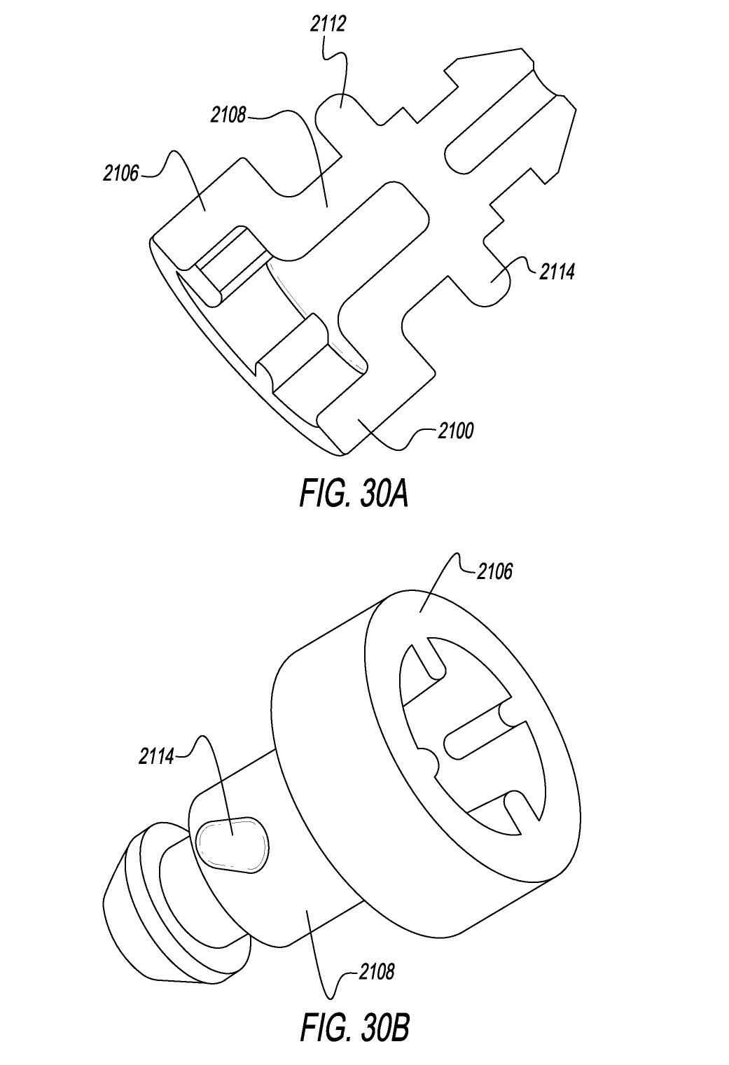

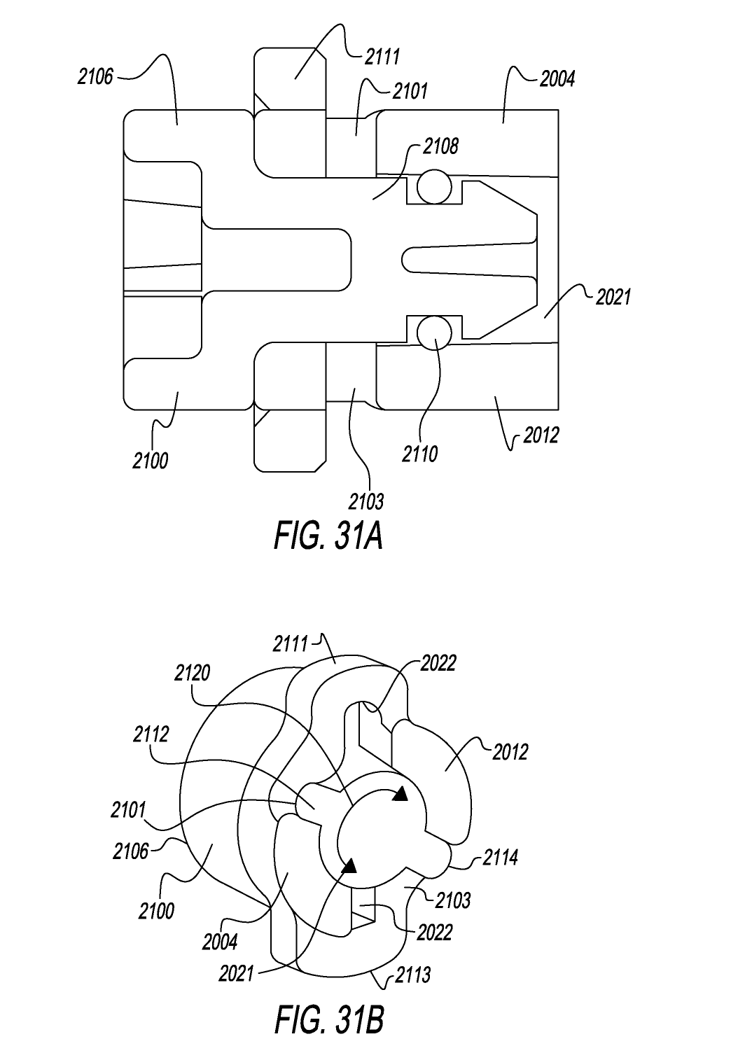

Referring to FIGS. 30a-31b, caps 2100 are rotatable in opposite directions, as shown by arrows 2120, when in conduit 2004 between an unlocked position, and, as shown in FIG. 31b, a locked position. For example, caps 2100 may be rotated 60 degrees between the unlocked position and locked position. Conduit 2004 forms grooves 2022 in each of end walls 2111 and 2113.

In use, protrusion 2112 is aligned with one of grooves 2022 in end wall 2111 so that protrusion 2112 passes through one of grooves 2022 in end wall 2111 in the unlocked position and protrusion 2114 is aligned with one of grooves 2022 in end wall 2113 so that protrusion 2114 passes through one of grooves 2022 in end wall 2113 in the unlocked position. Caps 2100 are rotated moving protrusion 2112 in conduit aperture 2101 out of alignment with one of grooves 2022 in end wall 2111 to the locked position and protrusion 2114 is moved in conduit aperture 2103 out of alignment with one of grooves 2022 in end wall 2113 to the locked position. In the locked position, if an attempt is made to move one of caps 2100 out of conduit 2004, protrusions 2112 and 2114 would contact wall 2012 of conduit 2004 preventing removal of caps 2100. When in the locked position, caps 2100 are rotated moving protrusion 2112 in conduit aperture 2101 into of alignment with one of grooves 2022 in end wall 2111 to the unlocked position and protrusion 2114 is moved in conduit aperture 2103 into alignment with one of grooves 2022 in end wall 2113 to the unlocked position. In the unlocked position, protrusion 2112 passes through one of grooves 2022 in end wall 2111 and protrusion 2114 passes through one of grooves 2022 in end wall 2113 to remove each of caps 2100 from conduit 2004. Rinse assembly 2000 prevents unintended removal of caps 2100 by establishing a locked position. Accordingly, caps 2100 will not be lost.

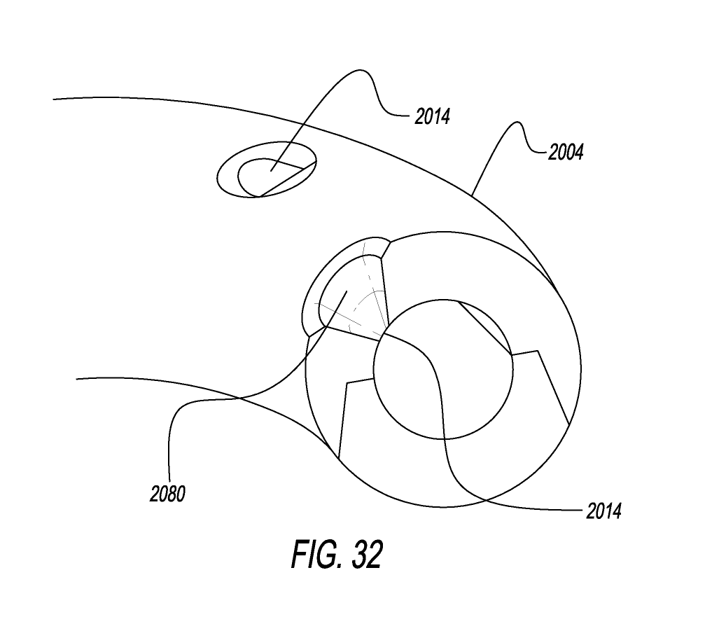

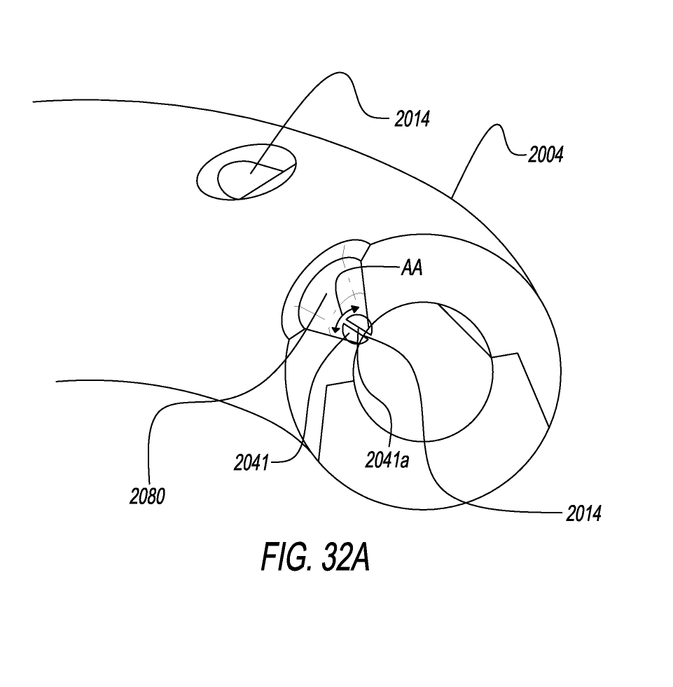

Referring to FIG. 32, a portion 2080 of conduit 2004 surrounding each of holes 2014 is shaped to direct in water that passes through holes 2014 in predetermined directions. For example, a conical shape may surround each of holes 2014. Each of holes 2014 is located around a perimeter of conduit 2004 to direct in water in predetermined directions. Alternatively, as shown in FIG. 32A, each of holes 2014 has an adjustable jet. The adjustable jet, for example, has an adjustable body 2041 that is spherical in shape having an orifice 2041a through adjustable body 2041. Adjustable body 2041 can be moved, for example, along arrow AA, by placing a tool or pin inside of orifice 2041a and applying a pressure in the desirable direction moving adjustable body 2041 until orifice 2041a is positioned in a desired position. Adjustable body 2041 may connect to conduit 2004 inside of one or more of holes 2014 by friction or snap fit.

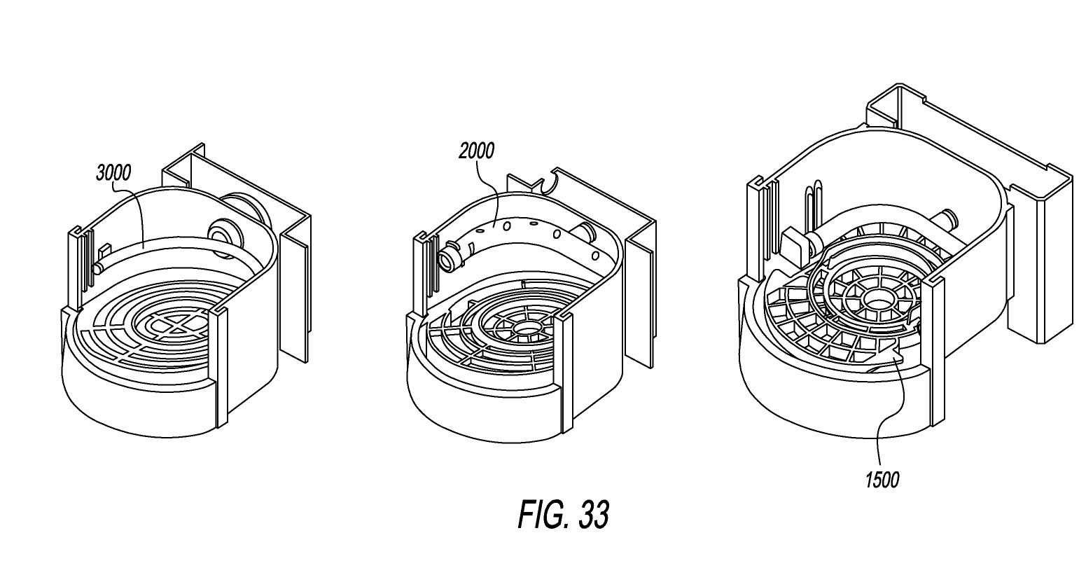

FIG. 33 are top side perspective views of another rinse assembly 3000, rinse assembly 2000 of FIG. 18 and rinse assembly 1500 of FIG. 17b.

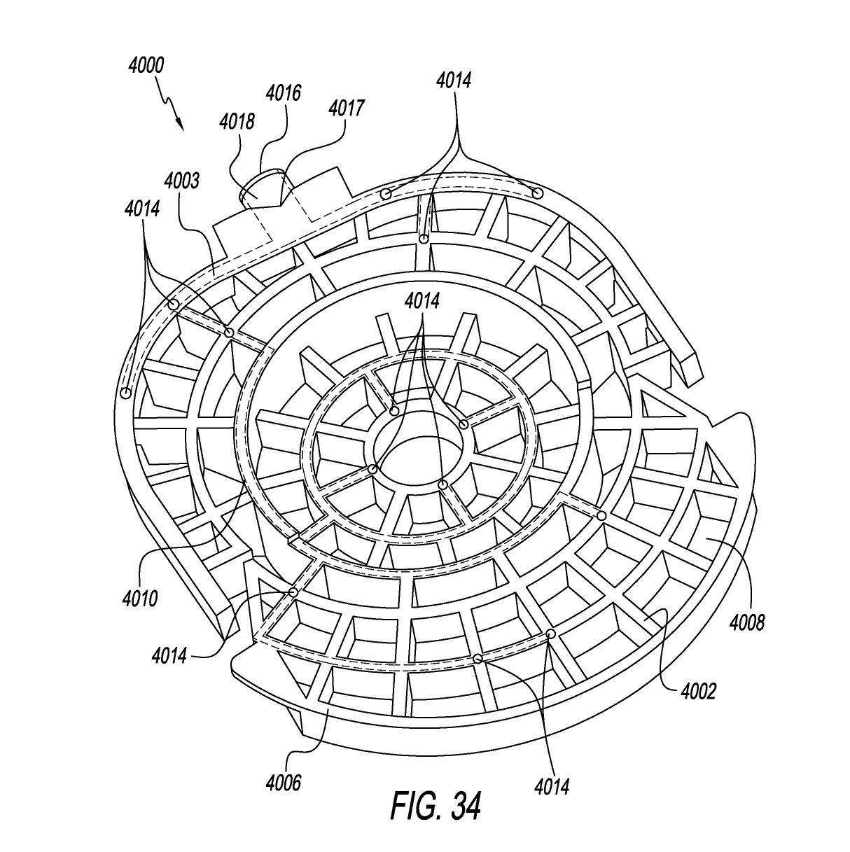

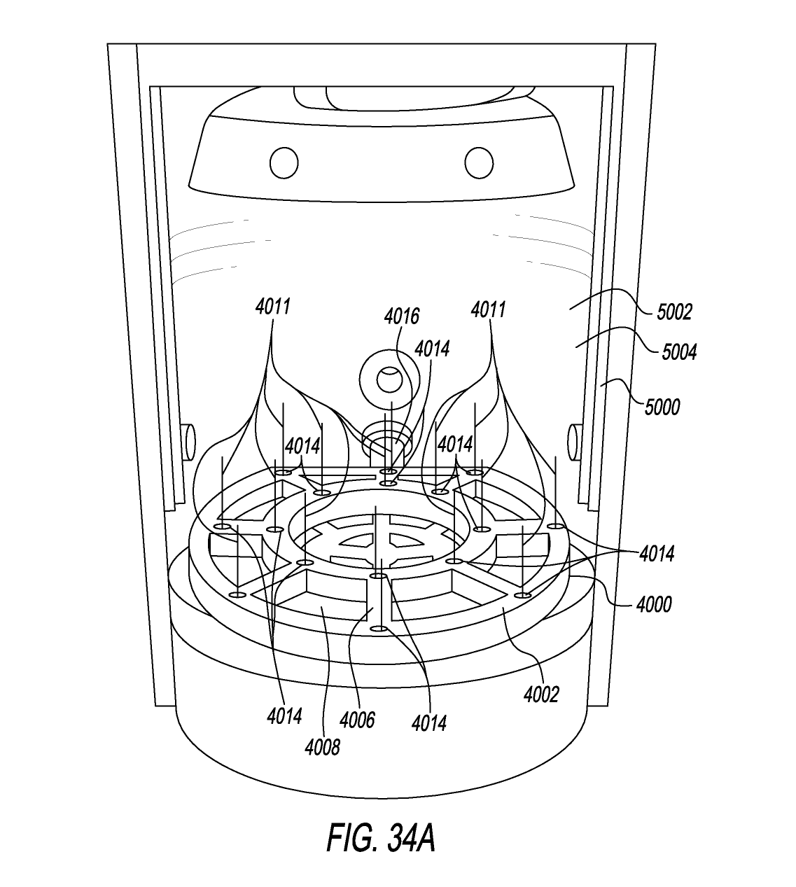

FIGS. 34-34A show another embodiment of a rinse assembly 4000. Rinse assembly 4000 has a grate 4002 to support a beverage container. Grate 4002 has frame members 4006 that form openings 4008 through grate 4002. Grate 4002 has a support member 4010 that extends outward from frame members 4006. Support member 4010 is shaped complementary to a container, for example, a plastic or Styrofoam cup, in which blending of a beverage takes place. Grate 4002 has a sidewall 4016 that surrounds a connection aperture 4018 therein. Sidewall 4016 is connected to an inlet end seal 4017. Inlet end seal 4017 is overmolded onto conduit sidewall 4016. Sidewall 4016 is connectable to a water source. Connection aperture 4018 is connected to conduits 4003 that are inside of grate 4002 that connect to holes 4014 through grate 4002. Conduits 4003 are formed by a dual wall structure. Holes 4014 may be shaped to direct water each in a predetermined direction. Rinse assembly 4000 may be incorporated into a blender 5000 similar to rinse assembly 1000 so that when rinse assembly 4000 is in place in blend chamber 5002, inlet end seal 4017 contacts side wall 5004 to align connection aperture 4018 and inlet opening 5022 through side wall 5004 and inlet opening 5022 communicates with water source. Water provided under pressure flows through inlet opening 5022 to connection aperture 4018 to conduits 4003 and out of holes 4014 to form a spray 4011 to spray blender chamber 5002 in the predetermined direction. FIGS. 34-34A show alternative shapes of grate 4002.

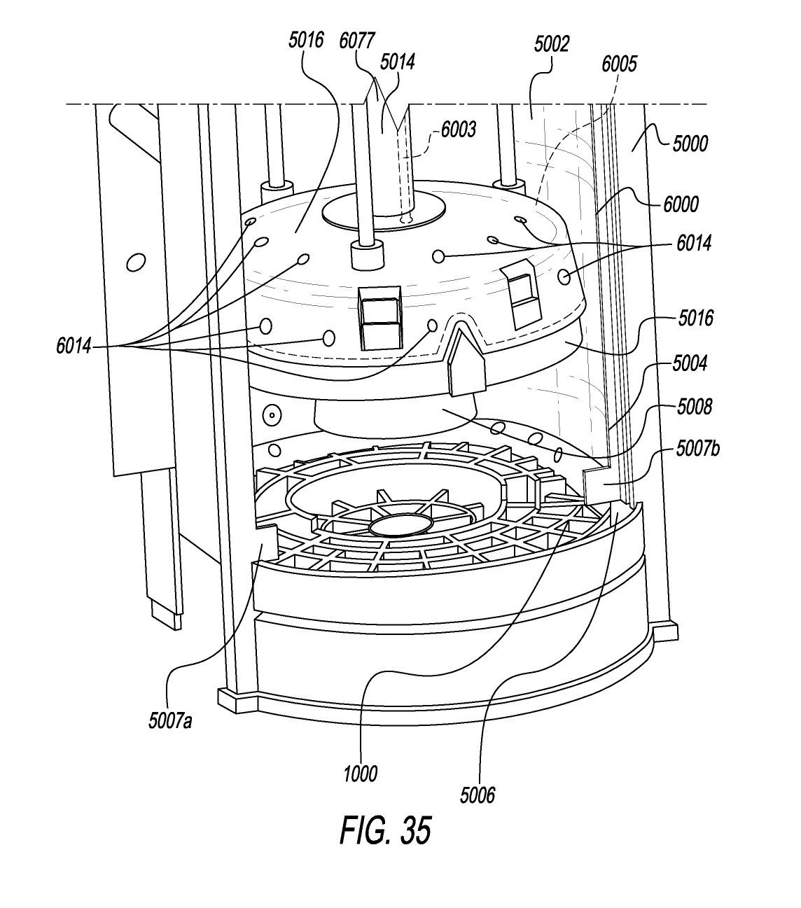

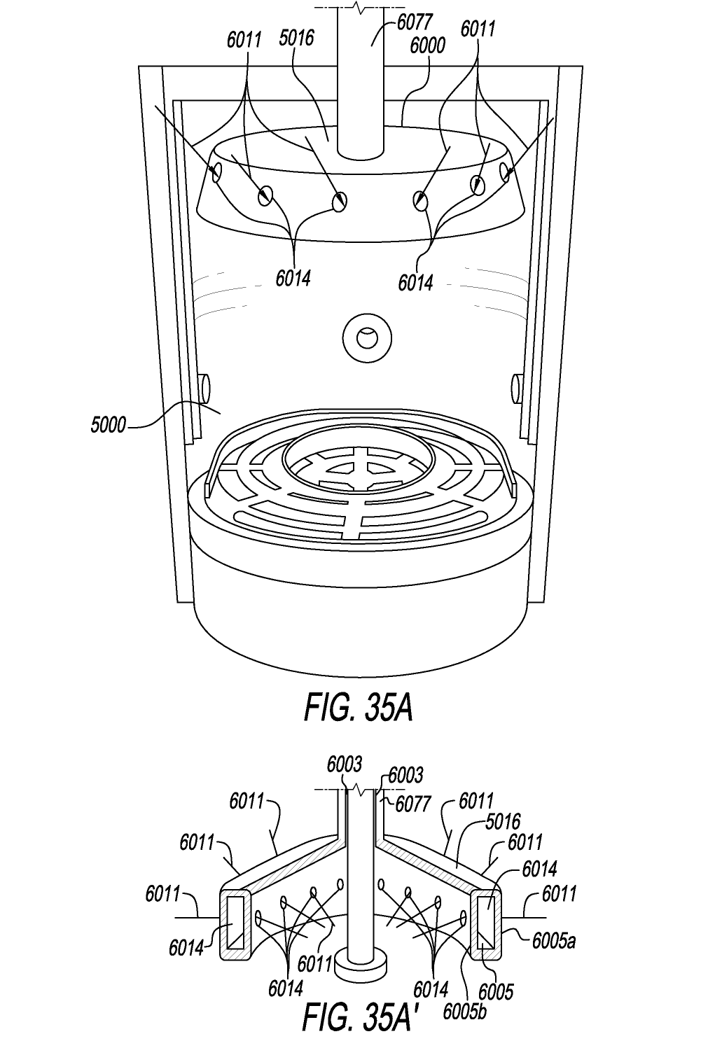

FIGS. 35-35A′ show another embodiment of a rinse assembly 6000. Rinse assembly 6000 is incorporated into container cover 5016 of blender 5000. Container cover 5016 has holes 6014 along its upper surface, lower surface (not shown) and/or side surfaces. Holes 6014 may be shaped to direct water each in a predetermined direction. A manifold 6005 formed by a first wall 6005a and second wall 6005b forming a dual wall structure or separate conduits each for one of holes 6014 connect holes 6014 to a conduit 6003. Conduit 6003 connects to a water source so that water provided under pressure flows through conduit 6003 to a cavity in manifold 6005 and out of holes 6014 to form a spray 6011 to spray blender chamber 5002 in the predetermined direction. As in previous embodiments, the holes can have various shapes and/or incorporate adjustment jet spray heads, and/or use continuous or pulsating streams of water, said water which may include cleaning or sanitizing fluid. Container cover 5016 is movable by a telescoping member 6077 that extends and retracts to move container cover 5016. Conduit 6003 may have a telescoping structure similar to telescoping member 6077 to extend and retract with the movement of telescoping member 6077.

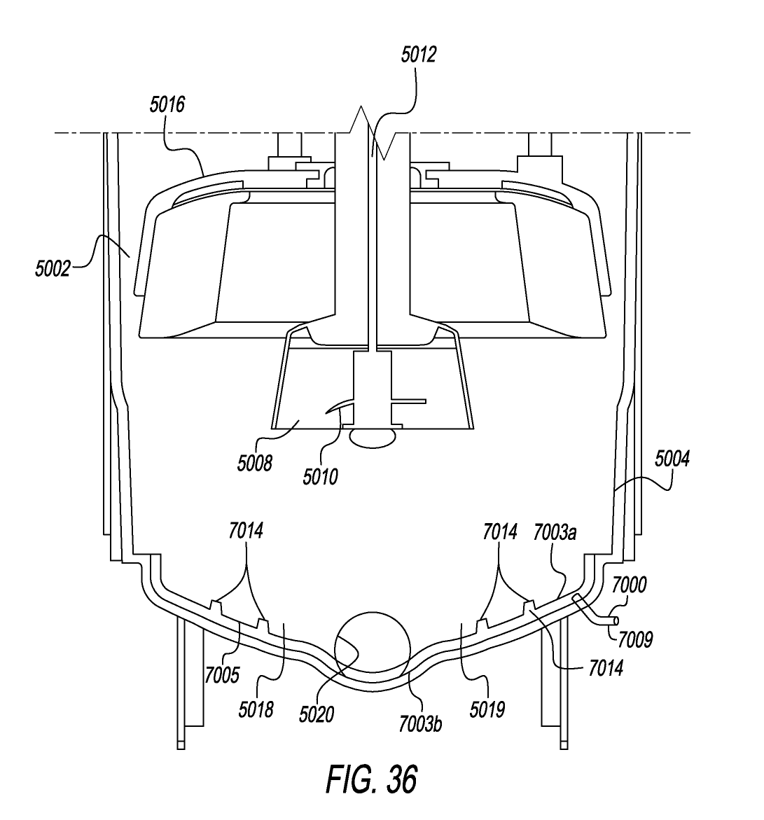

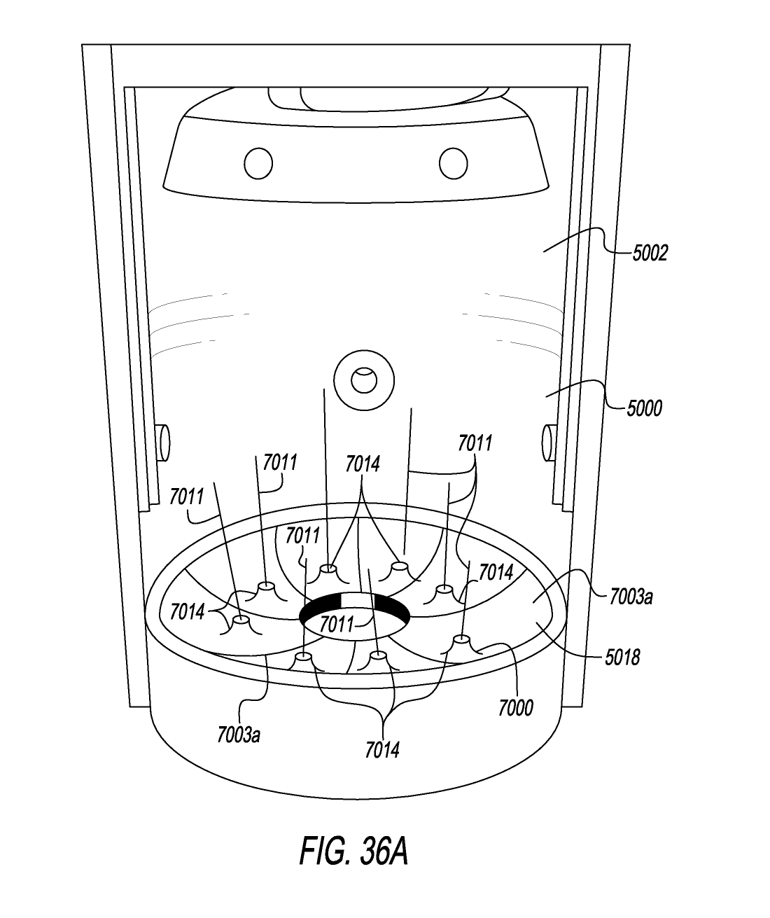

FIGS. 36-36A show another embodiment of a rinse assembly 7000. Rinse assembly 7000 is incorporated into sump cavity 5018 of blender 5000. Sump cavity 5018 has holes 7014 through a first wall 7003a. Holes 7014 may be shaped to direct water each in a predetermined direction. First wall 7003a forms a manifold 7005 with a second wall 7003b to form a dual wall structure. Manifold 7005 connects to a water source by conduit 7009 so that water provided under pressure flows through manifold 7005 to holes 7014 forming a spray 7011 to spray blender chamber 5002 in the predetermined direction. Alternatively, separate conduits for each of one of holes 7014 connect holes 7014 to conduit 7009. A grate may be placed above sump cavity 5018 to support a beverage container.

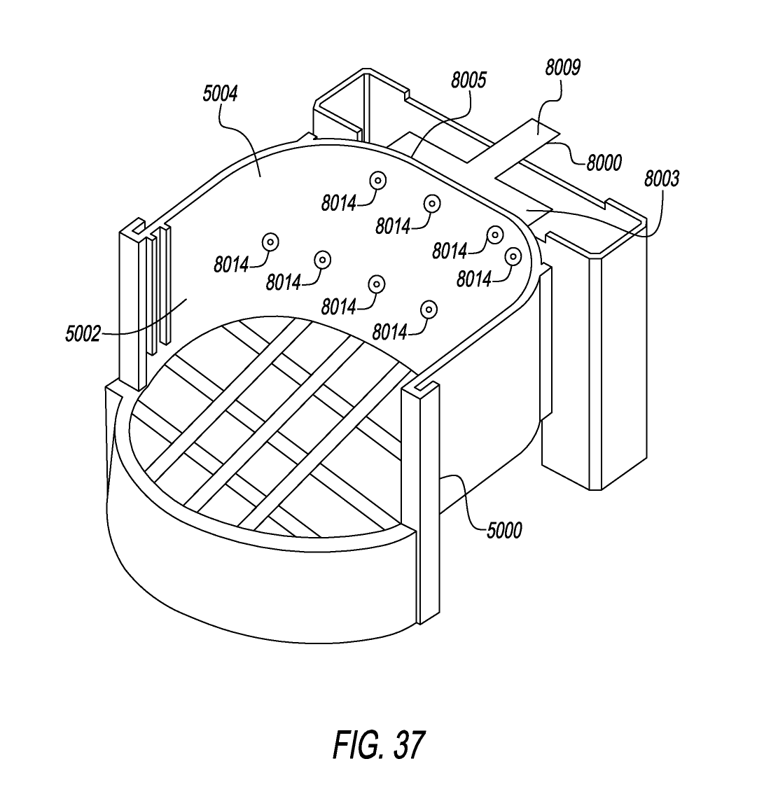

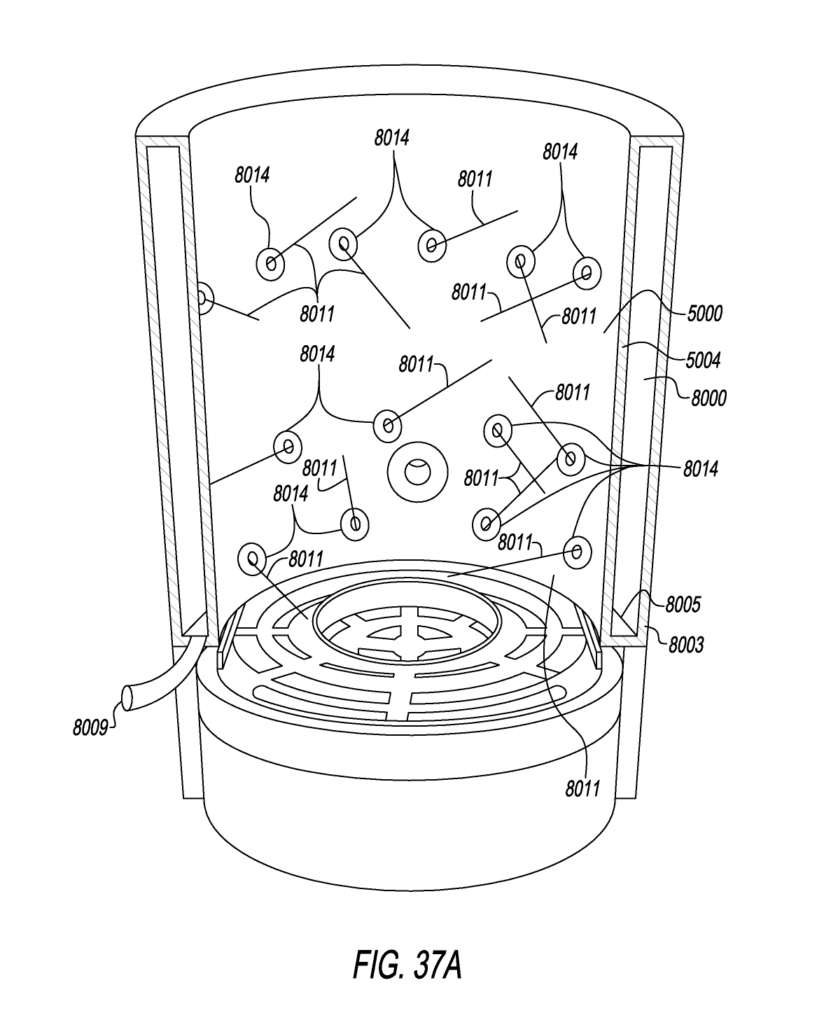

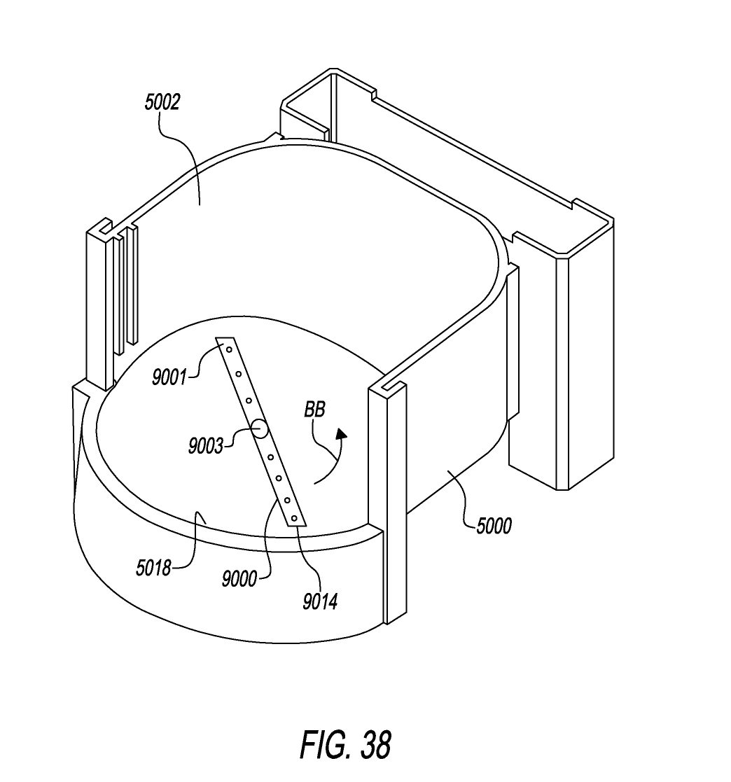

FIGS. 37-37A show another embodiment of a rinse assembly 8000. Rinse assembly 8000 is incorporated into side wall 5004 of blender 5000. Blender 5000 has holes 8014 through side wall 5004. Holes 8014 may be shaped to direct water each in a predetermined direction. First wall 8003 forms a manifold 8005 with side wall 5004 forming a dual wall structure. Manifold 8005 connects to a water source by conduit 8009 so that water provided under pressure flows through an inner cavity of manifold 8005 to distribute the water to holes 8014 to spray 8011 blender chamber 5002 in the predetermined directions. Alternatively, separate conduits for each of one of holes 8014 connect holes 8014 to conduit 8009.

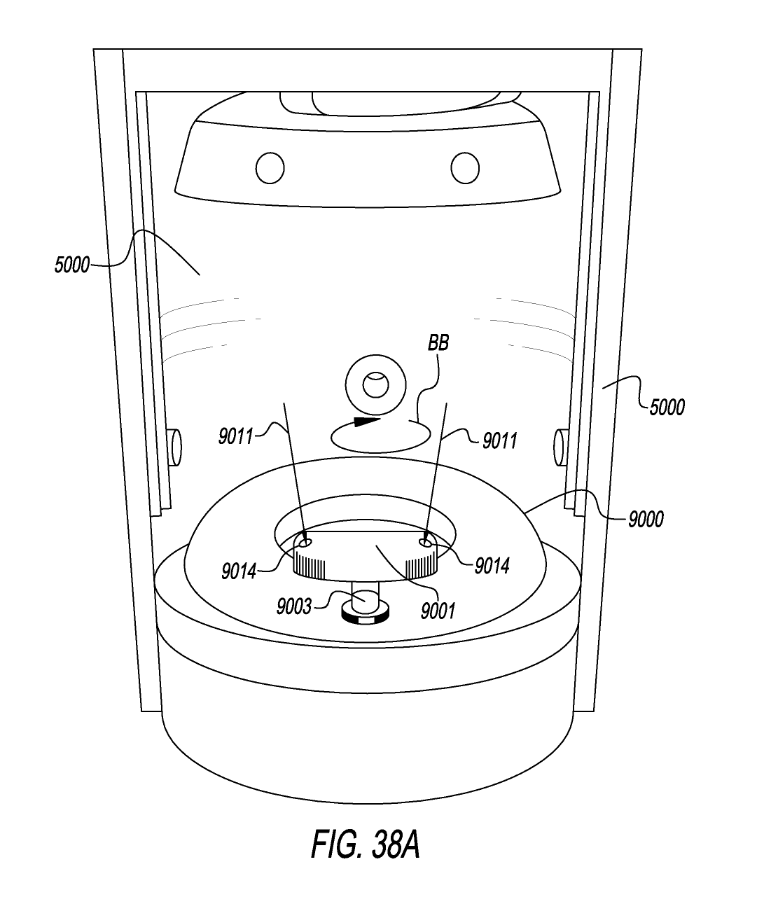

FIGS. 38-38A show another embodiment of a rinse assembly 9000. Rinse assembly 9000 has a conduit 9001 that is connected to a shaft 9003. Shaft 9003 rotates conduit 9001, as shown by arrow BB. Shaft 9003, for example, is connected to a motor that imparts rotation to shaft 9003 that rotates conduit 9001. Conduit 9001 is connected to a water source, preferably through shaft 9003 so that water provided under pressure flows through shaft 9003 through conduit 9001 and out of holes 9014 forming a spray 9011 to spray blender chamber 5002 of blender 5000 while shaft 9003 rotates conduit 9001. A grate may be placed above conduit 9001 to support a beverage container. FIGS. 38-38A show alternative shapes of conduit 9001.

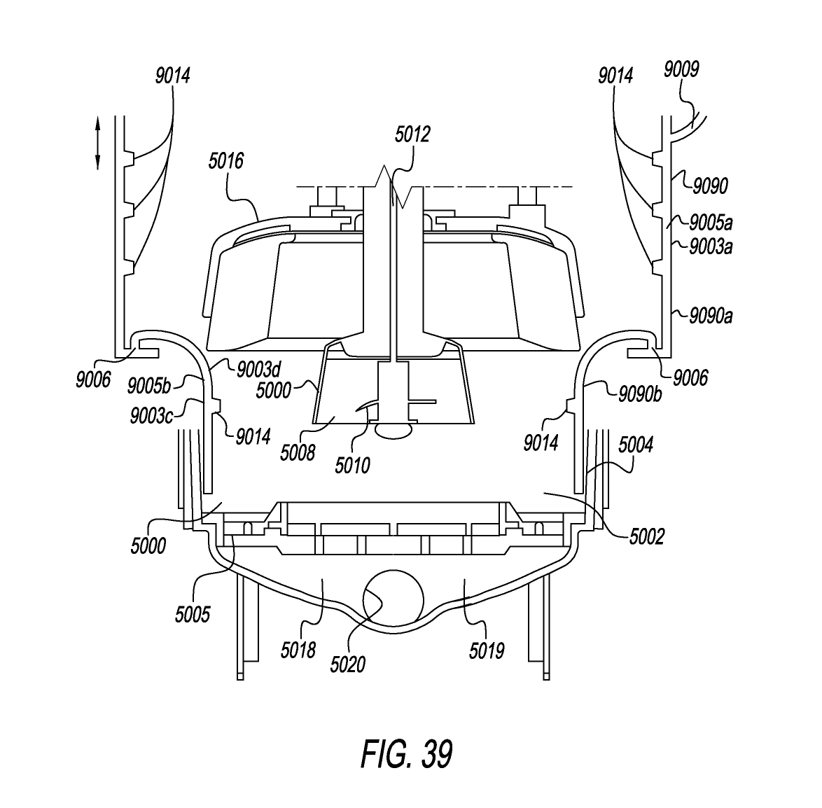

FIG. 39 is another embodiment of a rinse assembly 9000. Rinse assembly 9000 is incorporated into a telescoping door 9090 of blender 5000. Telescoping door 9090 replaces side wall 5004 and door 235 of blender/mixer/cleaning module 303 that is a part of an assembly that dispenses and mixes beverages as described in U.S. patent application Ser. No. 12/633,790, filed Dec. 8, 2009. Telescoping door 9090 has holes 9014 that may be shaped to direct water each in a predetermined direction. A first wall 9003a forms a manifold 9005a with a second wall 9003b forming a dual wall structure in a first segment 9090a of telescoping door 9090. A third wall 9003c forms a manifold 9005b with a fourth wall 9003d forming a dual wall structure in a second segment 9090b of telescoping door 9090. Manifold 9005b is connected to manifold 9005a at aperture 9006 connects to a water source by conduit 9009 so that water provided under pressure flows through an inner cavity of manifolds 9005a and 9005b to distribute the water to holes 9014 to spray blender chamber 5002 in the predetermined directions.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A rinse assembly comprising:
a grate having a frame forming a plurality of apertures; and
a conduit having a wall surrounding an interior cavity, said conduit having a shaped to conform to interior cavity walls of a blend chamber with a plurality of holes through said wall.

2. The rinse assembly of claim 1, wherein said conduit receives water that passes out said plurality of holes to rinse a blend chamber of a blender.

3. The rinse assembly of claim 1, wherein said blend chamber has a drain sump cavity connected to a drain, and wherein drain sump cavity has a cavity wall with a plurality of holes connected to a water source to form a spray through each of said plurality of holes through said cavity wall.

4. The rinse assembly of claim 1, wherein said conduit extends around an entire periphery of said grate.

5. The rinse assembly of claim 2, wherein said water is pulsated out of said plurality of holes.

6. The rinse assembly of claim 1, wherein said grate and said conduit are a one-piece structure that is removable.

7. The rinse assembly of claim 1, wherein said plurality of holes are a shape selected from the group consisting of ovals, circles, rectilinear, trapezoids, triangles, stars, and any combination thereof.

8. The rinse assembly of claim 1, wherein said conduit has a first end having a first opening and a second end having a second opening, and further comprising a first end seal that connects to said first end and a second end seal that connects to a second end, and wherein said first end seal is between said first end and a first surface of a blend chamber of a blender to seal said first end and said second end seal is between said second end and a second surface of the blend chamber to seal said second end.

9. The rinse assembly of claim 1, wherein said interior cavity walls of said blend chamber have a plurality of holes connected to a water source to form a spray through each of said plurality of holes through said interior cavity walls.

10. The rinse assembly of claim 1, wherein said conduit has a connection opening through said wall, and further comprising an inlet seal that is connected around said connection opening, wherein said connection opening is connectable to a water source so that said connection seal is between said conduit and said water source sealing said connection opening.

11. The rinse assembly of claim 1, wherein at least two of said plurality of holes are positioned at a different location along a perimeter of said conduit to direct water in different directions.

12. A rinse assembly comprising:
a conduit having a wall surrounding an interior cavity, said conduit having a curved shaping with a plurality of holes through said wall, said conduit having a first end having a first opening and a second end having a second opening;
a first end cap connectable to said conduit, said first end cap having a first unlocked position in which said first end cap is removable from said conduit and a first locked position in which said first end cap is fixed to said conduit; and
a second end cap connectable to said conduit, said second end cap having a second unlocked position in which said second end cap is removable from said conduit and a second locked position in which said second end cap is fixed to said conduit.

13. The rinse assembly of claim 12, wherein each of said first end cap and said second end cap is rotatable, and wherein said first end cap is rotatable between said first unlocked position and said first locked position and said second end cap is rotatable between said second unlocked position and said second locked position.

14. The rinse assembly of claim 13, wherein said first end cap has a first protrusion and said first opening in said conduit has a first groove and said second end cap has a second protrusion and said second opening in said conduit has a second groove, and wherein said first protrusion is aligned with said first groove so that said first protrusion passes through said first groove in said first unlocked position and said second protrusion is aligned with said second groove so that said second protrusion passes through said second groove in said second unlocked position, wherein said first end cap is rotated moving said first protrusion out of alignment with said first groove to said first locked position and said second end cap is rotated moving said second protrusion out of alignment with said second groove to said second locked position.

15. The rinse assembly of claim 1, wherein said blend chamber has a container cover that covers a container in which blending of a beverage takes place, and wherein said container cover has a plurality of holes connected to a water source to form a spray through each of said plurality of holes through said container cover.

16. The rinse assembly of claim 12, further comprising a first seal between said first end cap and said conduit and a second seal between said second end cap and said conduit.

17. A rinse assembly comprising:
a conduit having a wall surrounding an interior cavity, said conduit having a curved shape with a plurality of holes through said wall, said wall of said conduit directly contacting a surface of a blend chamber in a blender.

18. The rinse assembly of claim 17, wherein said conduit is a first conduit, further comprising a connection opening through said wall that is surrounded by a second conduit, and wherein said second conduit is connectable to a water source in said blend chamber, wherein said first conduit and/or said second conduit has a protrusion that restricts movement of the rinse assembly in an opening in said blend chamber to connect to said water source.

19. The rinse assembly of claim 1, further comprising a spring between said conduit and a blender chamber.

20. The rinse assembly of claim 1, wherein said grate has a plurality of holes connected to a water source to form a spray through each of said plurality of holes through said grate.

21. The rinse assembly of claim 1, wherein said at least one of said plurality of holes has an adjustable jet.

22. The rinse assembly of claim 1, further comprising an insert that is removably connected to said grate, wherein said insert supports a container in which blending takes place.

23. A rinse assembly comprising:
a blend chamber having a blender/mixer assembly;
a conduit in said blend chamber having a wall surrounding an interior cavity, said wall having a plurality of holes; and
a shaft connected to said conduit, said shaft rotates said conduit while said conduit receives water that is sprayed through said plurality of holes.

24. The rinse assembly of claim 23, wherein said blend chamber has a telescoping door, and wherein said telescoping door has a plurality of holes connected to a water source to form a spray through each of said plurality of holes through said telescoping door.
